(19) United States
(12) Patent Application Publication
(10) Pub. No.: US 2021/0227227 A1
(43) Pub. Date: Jul. 22, 2021

(54) SYSTEM AND METHOD FOR SUPPORTING PROGRESSIVE VIDEO BIT STREAM SWITCHING

(71) Applicant: SZ DJI TECHNOLOGY CO., LTD., Shenzhen (CN)

(72) Inventors: Wenjun ZHAO, Shenzhen (CN); Xiaozhen ZHENG, Shenzhen (CN)

(73) Assignee: SZ DJI TECHNOLOGY CO., LTD., Shenzhen (CN)

(21) Appl. No.: 17/193,942

(22) Filed: Mar. 5, 2021

Related U.S. Application Data
(63) Continuation of application No. PCT/CN2018/105108, filed on Sep. 11, 2018.

(51) Int. Cl. H04N 19/154; H04N 19/162; H04N 19/167; H04N 19/174; H04N 19/597; H04N 19/124; H04N 19/119; H04N 19/107; H04N 21/238

(52) U.S. Cl. CPC H04N 19/154; H04N 19/162; H04N 19/167; H04N 19/174; H04N 21/238; H04N 19/124; H04N 19/119; H04N 19/107; H04N 19/597

(57) ABSTRACT

System and method can support bit stream switching in video streaming. A distributed IDR picture transmission technique can be employed for reducing the delay, which is caused by the increase of amount of data to be transmitted, for performing bit stream switching. Additionally or alternatively, a progressive code stream switching technology can ensure smooth data stream transmission even when the bit stream switching happens.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The disclosed embodiments relate generally to video processing, more particularly, but not exclusively, to video streaming, encoding and decoding.

### BACKGROUND

The consumption of video content has been surging in recent years, mainly due to the prevalence of various types of portable, handheld, or wearable devices. For example, the virtual reality (VR) or augmented reality (AR) capability can be integrated into different head mount devices (HMDs). As the form of video content become more sophisticated, the storage and transmission of the video content become ever more challenging. For example, there is a need to reduce the bandwidth for video storage and transmission. This is the general area that embodiments of the invention are intended to address.

### SUMMARY

Described herein are systems and methods that can support video streaming. A distributed DR picture transmission technique can be employed for reducing the delay, which is caused by the increase of amount of data to be transmitted for performing bit stream switching in video streaming. Additionally or alternatively, a progressive code stream switching technology can ensure smooth data stream transmission even when the bit stream switching happens.

Also described herein are systems and methods that can support bit stream switching in video streaming. The system can use a scheme that partitions each image frame in a sequence of image frames into a plurality of sections, wherein the plurality of sections comprise at least a first section and a second section. The system can obtain a first set of encoded data in different coding qualities for the first section, and can obtain a second set of encoded data in different coding qualities for the second section. Additionally, the system can determine a first switching point that corresponds to a change of coding quality for the first section, and can determine a second switching point that corresponds to a change of coding quality for the second section. Furthermore, the system can select, from the first set of encoded data, encoded data with a first prior coding quality before the first switching point and encoded data with a first posterior coding quality after the first switching point. Also, the system can select, from the second set of encoded data, encoded data with a second prior encoding quality before a second switching point and encoded data with a second posterior encoding quality after a second switching point. Then, the system can incorporate the selected encoded data in a bit stream.

Also described herein are systems and methods that can support video streaming. The system can receive a bit stream that comprises binary data for reconstructing a sequence of image frames, wherein each image frame in the sequence of image frames is partitioned into a plurality of sections based on a partition scheme, wherein the plurality of sections comprise at least a first section and a second section. The system can generate, from the binary data, a first reconstructed image frame, wherein the first reconstructed image frame comprises first reconstructed image data for the first section and first reconstructed image data for the second section. The first reconstructed image data for the first section can be reconstructed with a first prior coding quality when the first reconstructed image frame is before a first switching point that corresponds to a change of coding quality for the first section, and the first reconstructed image data for the second section can be reconstructed with a second prior coding quality when the second reconstructed image frame is before a second switching point that corresponds to a change of coding quality for the second section. Also, the system can generate, from the binary data, a second reconstructed image data, wherein the second reconstructed image frame comprises second reconstructed image data for the first section and second reconstructed image data for the second section. The second reconstructed image data for the first section is reconstructed with a first posterior coding quality when the first reconstructed image frame is after the first switching point, and the second reconstructed image data for the first section is reconstructed with a second posterior coding quality when the second reconstructed image frame is after the second switching point.

### BRIEF DESCRIPTION OF THE DRAWINGS

FIG. 1 illustrates coding/compressing a curved view video, in accordance with various embodiments of the present invention.

FIG. 2 illustrates an exemplary equirectangular projection that can map a three dimensional spherical view to a two-dimensional plane, in accordance with various embodiments of the present invention.

FIG. 3 illustrates an exemplary cubic face projection that maps a three dimensional spherical view to a two-dimensional layout, in accordance with various embodiments of the present invention.

FIG. 4 illustrates mapping a curved view into a two-dimensional (2D) image, in accordance with various embodiments of the present invention.

FIG. 5 illustrates an exemplary video streaming environment, in accordance with various embodiments of the present invention.

FIG. 6 illustrates exemplary image partition schemes based on tiles, in accordance with various embodiments of the present invention.

FIG. 7 illustrates encoding an image frame sequence for supporting video streaming, in accordance with various embodiments of the present invention.

FIG. 8 illustrates supporting bit stream switching in video streaming using tiles, in accordance with various embodiments of the present invention.

FIG. 9 illustrates bit stream switching in video streaming using tiles, in accordance with various embodiments of the present invention.

FIG. 10 illustrates exemplary image partition schemes based on slices, in accordance with various embodiments of the present invention.

FIG. 11 illustrates encoding an image frame sequence for supporting video streaming, in accordance with various embodiments of the present invention.

FIG. 12 illustrates supporting bit stream switching in video streaming using slices, in accordance with various embodiments of the present invention.

FIG. 13 illustrates bit stream switching in video streaming using slices, in accordance with various embodiments of the present invention.

FIG. 14 illustrates an exemplary video streaming environment supporting bit stream switching, in accordance with various embodiments of the present invention.

FIG. 15 illustrates supporting distributive IDR picture transmitting in video streaming based on tiles, in accordance with various embodiments of the present invention.

FIG. 16 illustrates supporting distributive IDR picture transmitting in video streaming based on slices, in accordance with various embodiments of the present invention.

FIG. 17 illustrates configuring IDR picture insertion cycle based on importance ratings associated with different tiles, in accordance with various embodiments of the present invention.

FIGS. 18-19 illustrates performing bit stream switching at the server side based on the exemplary configuration as shown in FIG. 17(a).

FIGS. 20-21 illustrates performing bit stream switching at the server side based on the exemplary configuration as shown in FIG. 17(b).

FIG. 22 illustrates configuring IDR picture insertion cycle based on importance ratings associated with different slices, in accordance with various embodiments of the present invention.

FIGS. 23-24 illustrates performing bit stream switching at the server side based on the exemplary configuration as shown in FIG. 22(a).

FIGS. 25-26 illustrates performing bit stream switching at the server side based on the exemplary configuration as shown in FIG. 22(b).

FIG. 27 illustrates a flow chart for supporting bit stream switching in video streaming, in accordance with various embodiments of the present invention.

FIGS. 28-29 illustrates performing bit stream switching at the terminal side based on the exemplary configuration as shown in FIG. 17(a).

FIGS. 30-31 illustrates performing bit stream switching at the terminal side based on the exemplary configuration as shown in FIG. 17(b).

FIGS. 32-33 illustrates performing bit stream switching at the terminal side based on the exemplary configuration as shown in FIG. 22(a).

FIGS. 34-35 illustrates performing bit stream switching at the terminal side based on the exemplary configuration as shown in FIG. 22(b).

FIG. 36 illustrates a flow chart for supporting video streaming, in accordance with various embodiments of the present invention.

FIG. 37 illustrates a movable platform environment, in accordance with various embodiments of the present invention.

### DETAILED DESCRIPTION OF THE EMBODIMENTS

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

In accordance with various embodiments of the present invention, systems and methods can support bit stream switching in video streaming. The system can partition each image frame in a sequence of image frames into a plurality of sections, wherein the plurality of sections comprise at least a first section and a second section, can obtain a first set of encoded data in different coding qualities for the first section, and can obtain a second set of encoded data in different coding qualities for the second section. Additionally, the system can determine a first switching point that corresponds to a change of coding quality for the first section, and can determine a second switching point that corresponds to a change of coding quality for the second section. Furthermore, the system can select, from the first set of encoded data, encoded data with a first prior coding quality before the first switching point and encoded data with a first posterior coding quality after the first switching point. Also, the system can select, from the second set of encoded data, encoded data with a second prior encoding quality before a second switching point and encoded data with a second posterior encoding quality after a second switching point. Then, the system can incorporate the selected encoded data in a bit stream.

In accordance with various embodiments of the present invention, systems and methods can support video streaming. The system can receive a bit stream that comprises binary data for reconstructing a sequence of image frames, wherein each image frame in the sequence of image frames is partitioned into a plurality of sections based on a partition scheme, wherein the plurality of sections comprise at least a first section and a second section. The system can generate, from the binary data, a first reconstructed image frame, wherein the first reconstructed image frame comprises first reconstructed image data for the first section and first reconstructed image data for the second section. The first reconstructed image data for the first section can be reconstructed with a first prior coding quality when the first reconstructed image frame is before a first switching point that corresponds to a change of coding quality for the first section, and the first reconstructed image data for the second section can be reconstructed with a second prior coding quality when the second reconstructed image frame is before a second switching point that corresponds to a change of coding quality for the second section. Also, the system can generate, from the binary data, a second reconstructed image data, wherein the second reconstructed image frame comprises second reconstructed image data for the first section and second reconstructed image data for the second section. The second reconstructed image data for the first section is reconstructed with a first posterior coding quality when the first reconstructed image frame is after the first switching point, and the second reconstructed image data for the first section is reconstructed with a second posterior coding quality when the second reconstructed image frame is after the second switching point.

In accordance with various embodiments of the present invention, a distributed IDR picture transmission technique can be employed for reducing the delay, which is caused by the increase of amount of data to be transmitted for performing bit stream switching in video streaming. Additionally or alternatively, a progressive code stream switching technology can ensure smooth data stream transmission even when the bit stream switching happens.

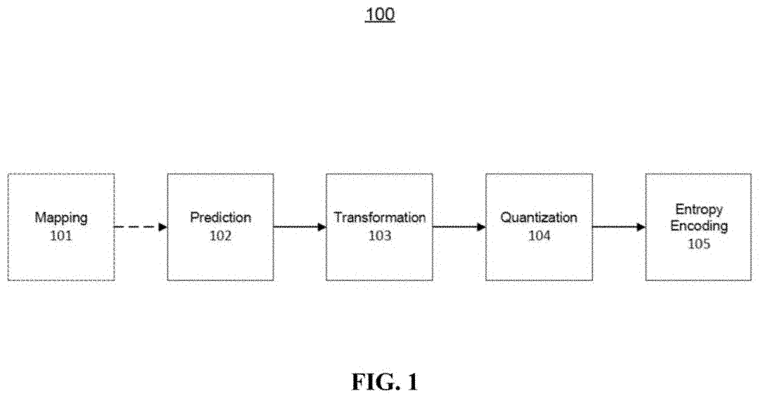

FIG. 1 illustrates coding/compressing a video, in accordance with various embodiments of the present invention. As shown in FIG. 1, the coding/compressing of a panoramic or wide view video, such as a curved view video, can involve multiple steps, such as mapping 101, prediction 102, transformation 103, quantization 104, and entropy encoding 105.

In accordance with various embodiments, at the mapping step 101, the system can project a three dimensional (3D) curved view in a video sequence on a two-dimensional (2D) plane in order to take advantage of various video coding/compressing techniques. The system can use a two-dimensional rectangular image format for storing and transmitting the curved view video (e.g. a spherical view video). Also, the system can use a two-dimensional rectangular image format for supporting the digital image processing and performing codec operations.

Different approaches can be employed for mapping a curved view, such as a spherical view, to a rectangular image. For example, a spherical view can be mapped to a rectangular image based on an equirectangular projection. In some embodiments, an equirectangular projection can map meridians to vertical straight lines of constant spacing and can map circles of latitude to horizontal straight lines of constant spacing. Alternatively, a spherical view can be mapped into a rectangular image based on cubic face projection. A cubic face projection can approximate a 3D sphere surface based on its circumscribed cube. The projections of the 3D sphere surface on the six faces of the cube can be arranged as a 2D image using different cubic face layouts, which defines cubic face arrangements such as the relative position and orientation of each individual projection. Apart from the equirectangular projection and the cubic face projection as mentioned above, other projection mechanisms can be exploited for mapping a 3D curved view into a 2D video. A 2D video can be compressed, encoded, and decoded based on some commonly used video codec standards, such as HEVC/H.265, H.264/AVC, AVS1-P2, AVS2-P2, VP8, VP9.

In accordance with various embodiments, the prediction step 102 can be employed for reducing redundant information in the image. The prediction step 102 can include intra-frame prediction and inter-frame prediction. The intra-frame prediction can be performed based solely on information that is contained within the current frame, independent of other frames in the video sequence. Inter-frame prediction can be performed by eliminating redundancy in the current frame based on a reference frame, e.g. a previously processed frame.

For example, in order to perform motion estimation for inter-frame prediction, a frame can be divided into a plurality of image blocks. Each image block can be matched to a block in the reference frame, e.g. based on a block matching algorithm. In some embodiments, a motion vector, which represents an offset from the coordinates of an image block in the current frame to the coordinates of the matched image block in the reference frame, can be computed. Also, the residuals, i.e. the difference between each image block in the current frame and the matched block in the reference frame, can be computed and grouped.

Furthermore, the redundancy of the frame can be eliminated by applying the transformation step 103. In the transformation step 103, the system can process the residuals for improving coding efficiency. For example, transformation coefficients can be generate by applying a transformation matrix and its transposed matrix on the grouped residuals. Subsequently, the transformation coefficients can be quantized in a quantization step 104 and coded in an entropy encoding step 105. Then, the bit stream including information generated from the entropy encoding step 105, as well as other encoding information (e.g., intra-frame prediction mode, motion vector) can be stored and transmitted to a decoder.

At the receiving end, the decoder can perform a reverse process (such as entropy decoding, dequantization and inverse transformation) on the received bit stream to obtain the residuals. Thus, the image frame can be decoded based on the residuals and other received decoding information. Then, the decoded image can be used for displaying the curved view video.

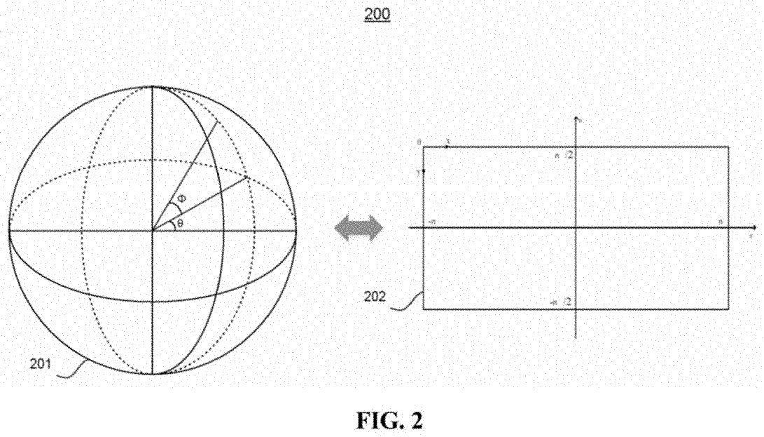

FIG. 2 illustrates an exemplary equirectangular projection 200 that can map a three dimensional spherical view to a two-dimensional plane, in accordance with various embodiments of the present invention. As shown in FIG. 2, using an equirectangular projection, the sphere view 201 can be mapped to a two-dimensional rectangular image 202. On the other hand, the two-dimensional rectangular image 202 can be mapped back to the sphere view 201 in a reverse fashion.

In some embodiments, the mapping can be defined based on the following equations.

x=λ cos φ₁ (Equation 1)

Y=φ (Equation 2)

Wherein x denotes the horizontal coordinate in the 2D plane coordinate system, and y denotes the vertical coordinate in the 2D plane coordinate system 202. A denotes the longitude of the sphere 201 from the central merdian, while φ denotes the latitude of the sphere from the the standard parallels. φ₁ denotes the standard parallels where the scale of the projection is true. In some embodiments, φ₁ can be set as 0, and the point (0, 0) of the coordinate system 202 can be located in the center.

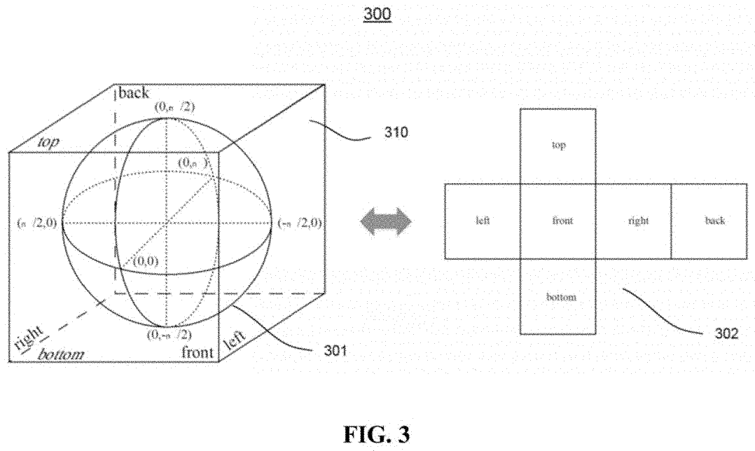

FIG. 3 illustrates an exemplary cubic face projection that maps a three dimensional spherical view to a two-dimensional layout, in accordance with various embodiments of the present invention. As shown in FIG. 3, using a cubic face projection, a sphere view 301 can be mapped to a two-dimensional layout 302. On the other hand, the two-dimensional layout 302 can be mapped back to the sphere view 301 in a reverse fashion.

In accordance with various embodiments, the cubic face projection for the spherical surface 301 can be based on a cube 310, e.g. a circumscribed cube of the sphere 301. In order for ascertaining the mapping relationship, ray casting can be performed from the center of the sphere to obtain a number of pairs of intersection points on the spherical surface and on the cubic faces respectively.

As shown in FIG. 3, an image frame for storing and transmitting a spherical view can include six cubic faces of the cube 310, e.g. a top cubic face, a bottom cubic face, a left cubic face, a right cubic face, a front cubic face, and a back cubic face. These six cubic faces may be expanded on (or projected to) a 2D plane.

It should be noted that the projection of a curved view such as a spherical view or an ellipsoidal view based on cubic face projection is provided for the purposes of illustration, and not intended to limit the scope of the present disclosure. For persons having ordinary skills in the art, various modifications and variations can be conducted under the teachings of the present disclosure Exemplary embodiments of projection formats for the projection pertaining to the present disclosure may include octahedron, dodecahedron, icosahedron, or any polyhedron. For example, the projections on eight faces may be generated for an approximation based on an octahedron, and the projections on those eight faces can be expanded and/or projected onto a 2D plane. In another example, the projections on twelve faces may be generated for an approximation based on a dodecahedron, and the projections on those twelve faces can be expanded and/or projected onto a 2D plane. In yet another example, the projections on twenty faces may be generated for an approximation based on an icosahedron, and the projections on those twenty faces can be expanded and/or projected onto a 2D plane. In yet another example, the projections of an ellipsoidal view on various faces of a polyhedron may be generated for an approximation of the ellipsoidal view, and the projections on those twenty faces can be expanded and/or projected onto a 2D plane.

It still should be noted that for the cubic face layout illustrated in FIG. 3, the different cubic faces can be depicted using its relative position, such as a top cubic face, a bottom cubic face, a left cubic face, a right cubic face, a front cubic face, and a back cubic face. Such depiction is provided for the purposes of illustration only, and not intended to limit the scope of the present disclosure. For persons having ordinary skills in the art, various modifications and variations can be conducted under the teachings of the present disclosure.

In accordance with various embodiments, depending on the orientation or relative position of each cubic face, the continuous relationship among various cubic faces can be represented using different continuity relationships.

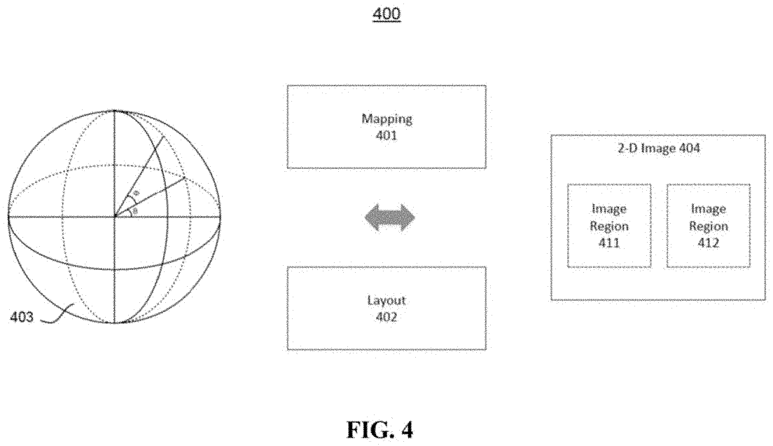

FIG. 4 illustrates mapping a curved view into a two-dimensional (2D) image, in accordance with various embodiments of the present invention. As shown in FIG. 4, a mapping 401 can be used for corresponding a curved view 403 to a 2D image 404. The 2D image 404 can comprise a set of image regions 411-412, each of which contains a portion of the curved view 403 projected on a face of a polyhedron (e.g. a cube).

In accordance with various embodiments, the set of image regions can be obtained by projecting said at least one portion of the curved view to a plurality of faces on a polyhedron. For example, a spherical view 403 can be projected from a spherical surface, or a portion of a spherical surface, to a set of cubic faces. In a similar fashion, a curved view can be projected from an ellipsoid surface, or a portion of an ellipsoid surface, to a set of rectangular cubic surfaces.

Furthermore, a curved view, e.g. a spherical view 403, can be mapped into a two-dimensional rectangular image 404 based on different layouts. As shown in FIG. 4, the set of image regions 411-412 can be arranged in the 2-D image 404 based on a layout 402, which defines the relative positional information, such as location and orientation, of the image regions 411-412 in the 2-D image.

As shown in FIG. 4, the spherical view 403 is continuous on every direction. In accordance with various embodiments, a set of image regions 411-412 can be obtained by projecting at least a portion of the curved view 403 to a plurality of faces on a polyhedron. The continuous relationship can be represented using a continuity relationship, which is pertinent to a particular mapping 401 and layout 402. Due to the geometry limitation, the two-dimensional image 404 may not be able to fully preserve the continuity in the spherical view 403.

In accordance with various embodiments, the system can employ a padding scheme for providing or preserving the continuity among the set of image regions 411-412 in order to improve the efficiency in encoding/decoding a spherical view video.

In accordance with various embodiments, various mapping mechanisms can be used for mapping a curved view, e.g. a spherical view 403, into a two-dimensional planar view (i.e., a curved view video can be mapped to a two-dimensional planar video). The spherical video or the partial spherical video can be captured by a plurality of cameras or a wide view camera such as a fisheye camera. The two-dimensional planar video can be obtained by a spherical mapping and can also be obtained via partial spherical mapping. The mapping method may be applied to provide a representation of a 360-degree panoramic video, a 180-degree panoramic video, or a video with a wide field of view (FOV). Furthermore, the two-dimensional planar video obtained by the mapping method can be encoded and compressed by using various video codec standards, such as HEVC/H.265, H.264/AVC, AVS1-P2, AVS2-P2, VP8 and VP9.

In accordance with various embodiments, a panoramic or wide view video, such as a 360-degree panoramic video or video with a larger field of view (FOV) may contain a large amount of data. Also, such video may need to be encoded with a high coding quality and may need to be presented with a high resolution. Thus, even after mapping and compression (e.g. using various video codec methods), the size of the compressed data may still be large. As a result, the transmission of the panoramic or wide view video remains a challenging task at the current network transmission conditions.

In accordance with various embodiments, various approaches can be used for encoding and compressing the panoramic or wide view video. For example, an approach based on viewport can be used, in order to reduce the consumption of network bandwidth, while ensuring the user to view the panoramic or wide view video with satisfactory subjective feelings. Here, the panoramic or wide view video may cover a view wider than a human sight, and a viewport can represent the main perspective in the human sight, where more attention is desirable. On the other hand, the area outside the viewport, which may only be observable via peripheral vision or not observable by a human, may require less attention.

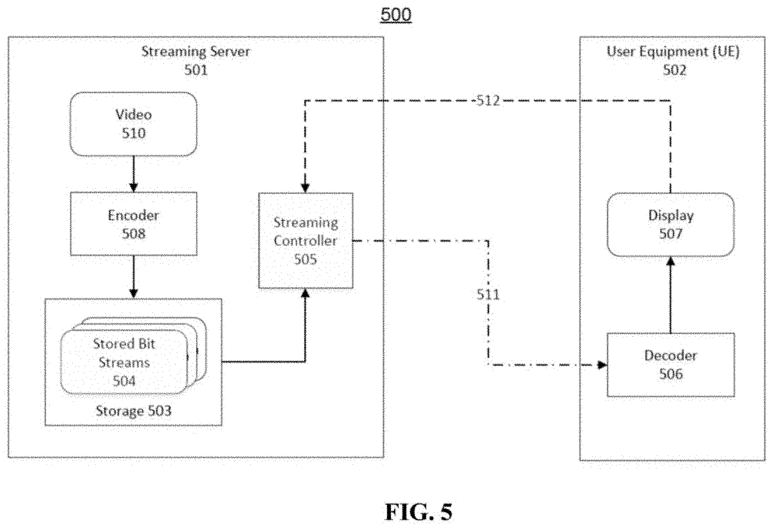

FIG. 5 illustrates an exemplary video streaming environment, in accordance with various embodiments of the present invention. As shown in FIG. 5, a video 510, e.g. a panoramic or wide view video with a large field of view (FOV), which may include a sequence of image frames (or pictures), can be streamed from a streaming server 501 to a user equipment (UE) 502 in a video streaming environment 500.

At the server side, an encoder 508 can encode the sequence of image frames in the video 510 and incorporate the encoded data into various bit streams 504 that are stored in a storage 503.

In accordance with various embodiments, a streaming controller 505 can be responsible for controlling the streaming of the video 510 to the user equipment (UE) 502. In some instances, the streaming controller 505 can be an encoder or a component of an encoder. In some instances, the streaming controller 505 may include an encoder or function together with an encoder. For example, the streaming controller 505 can receive user information 512, such as viewport information, from the user equipment (UE) 502. Then, the streaming controller 505 can generate a corresponding bit stream 511 based on the stored bit streams 504 in the storage 503, and transmit the generated bit stream 511 to the user equipment (UE) 502.

At the user equipment (UE) side, a decoder 506 can obtain the bit stream 511 that contains the binary data for the sequence of image frames in the video 510. Then, the decoder 506 can decode the binary data accordingly, before providing the decoded information to a display 506 for being viewed by a user. On the other hand, the user equipment (UE) 502, or a component of the user equipment (UE) 502 (e.g. a display 507), can obtain updated user information, such as updated view port information (e.g. when the user's sight moves around), and provide such updated user information back to the streaming server 501. Accordingly, the streaming controller 505 may reconfigure and transmit the bit stream 511 to the user equipment (UE) 502.

In accordance with various embodiments, different types of partition schemes can be used for partitioning each of the image frames in the video 510 into a plurality of sections. For example, the partition scheme can be based on tiles or slices, or any other geometry divisions that are beneficial in video encoding and decoding. In various instances, each of the image frames in the video 510 can be partitioned into a same number of sections. Also, corresponding sections in the different image frames can be positioned at the same or substantial similar relative locations and with or substantial similar same geometry sizes (e.g. each of the image frames in the video 510 can be partitioned in a same or substantial similar fashion).

In accordance with various embodiments, each of the plurality of sections partitioning an image frame can be configured with multiple levels of coding qualities. For example, at the server side, each of the plurality of sections partitioning an image frame can be configured with multiple levels of encoding qualities. At the user equipment (UE) side, each of the plurality of sections partitioning an image frame can be configured with multiple levels of decoding qualities.

In accordance with various embodiments, the coding quality for each section in an image frame in the video 510 can be determined based on user preference, such as region of interest (ROI) information. Alternatively or additionally, the coding quality for each section in the image frames can be determined based on viewport information for the first image frame, which can indicate a location of a viewport for the image frame. Here, a section in the image frame corresponding to the viewport can be configured to have a higher level of coding quality than the coding quality for another section in the image frame, which is outside of the viewport.

As shown in FIG. 5, at the server side, a plurality of bit streams 504 for the sequence of image frames in the video 510 can be stored in the storage 503. In some instances, each of the stored bit stream may contain encoded data, with a particular coding quality, for a particular section in the sequence of image frames.

In accordance with various embodiments, the encoder 508 can take advantage of an encoding process as shown in FIG. 1. For example, the encoder 508 can prepare for encoding a sequence of image frames in the video 510 using different coding qualities, by sharing various encoding steps such as the prediction and transformation steps. At the quantization step, the encoder 508 can apply different quantization parameters on the sequence of image frames while sharing prediction and transformation results. Thus, the encoder 508 can obtain multiple bit streams for the sequence of image frames with different coding qualities.

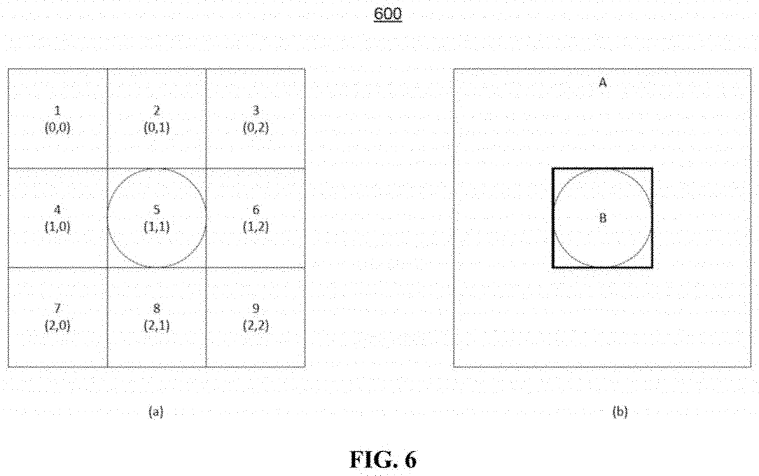

FIG. 6 illustrates exemplary image partition schemes 600 based on tiles, in accordance with various embodiments of the present invention. As shown in FIG. 6(a) and FIG. 6(b), a number of tiles can be used for partitioning an image frame (or picture) in a video.

In accordance with various embodiments, a tile, which is a rectangular region in an image frame, can be used for coding. For example, in various video codec standards, an image frame can be partitioned, horizontally and vertically, into tiles. In some video coding standards, such as HEVC/H.265, the height of the tiles in a same row may be required to be uniform, and the width of the tile in an image frame may not be required to be uniform. Data in different tiles in the same image frame may not be cross-referenced and predicted (although filtering operations may be performed crossing the boundaries of different tiles in the same image). The filtering operations can include deblocking, sample adaptive offset (SAO), adaptive loop filter (ALF), and etc.

In the example as shown in FIG. 6(a), an image can be partitioned into nine sections (or regions). Each section can be encoded with different qualities. In various instances, the coding quality can be defined either quantitatively or qualitatively. For example, the coding quality may be defined as one of “High”, “Medium” or “Low” (each of which may be associated with a quantitative measure). Alternatively or additionally, the coding quality can be represented by numbers, characters, alphanumeric strings, or any other suitable representations. In various instances, the coding quality may refer to various coding objective measures, subjective measures, and different sampling ratios (or resolutions).

As shown in FIG. 6(a), the tile 5, i.e. area (1, 1), is covered by the viewport. Thus, the tile 5 may be assigned with a “High” quality. Furthermore, the tiles 2, 4, 6, and 8, i.e. the areas (0, 1), (1, 0), (2, 1) and (1, 2), are adjacent to the area (1, 1) corresponding to the viewport. Thus, these areas can be encoded with a “Medium” quality, since these areas are in the sight of human eye (i.e. within peripheral vision) even though they are not the focus. Additionally, the tiles 1, 3, 7, and 9, i.e. the areas (0,0), (0,2), (2,0), and (2,2), are farther away from the viewport and may not be observable by the human eye. Thus, these areas may be encoded with a “Low” quality.

Alternatively, in the example as shown in FIG. 6(b), an image can be partitioned into two sections or areas. Each section can be encoded with different qualities, and the coding quality may be defined as one of “High”, “Medium” or “Low”. As shown in FIG. 6(b), section B (e.g. a tile) is covered by the viewport. Thus, the section B may be assigned with a “High” quality. Furthermore, section A, which surrounding the section B, may be assigned with a “Low” or “Medium” quality.

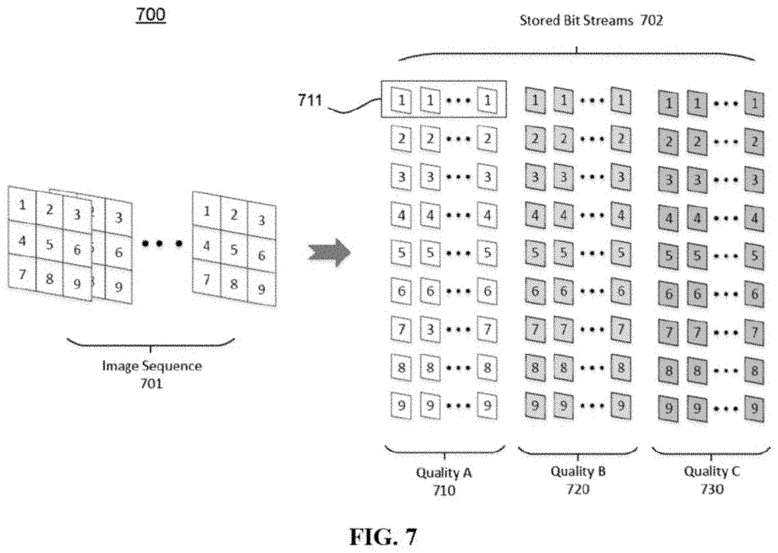

FIG. 7 illustrates encoding an image frame sequence for supporting video streaming, in accordance with various embodiments of the present invention. As shown in FIG. 7, an image sequence 701 can be encoded and stored as bit streams 702 in the sever 700. Here, each bit stream can be provided with a particular quality for a single section on the server side. For example, a stored bit stream 711 corresponds to encoded data with quality A (e.g. “High”) for section 1 in the image sequence.

As shown in FIG. 7, an image frame in the image sequence 701 (i.e. the video) can be partitioned into nine sections, while each section may be encoded with three qualities (e.g. A for “High”, B for “Medium” or C for “Low”). For example, the encoding can be based on various video codec standards, such as H.264/AVC, H.265/HEVC, AVS1-P2, AVS1-P2 etc.

In accordance with various embodiments, each bit stream is capable of being independent decoded. For example, each bit stream may contain independent video parameter set (VPS) information, independent sequence header information, independent sequence parameter set (SPS) information, independent picture header information, or a separate Picture Parameter Set (PPS) parameter.

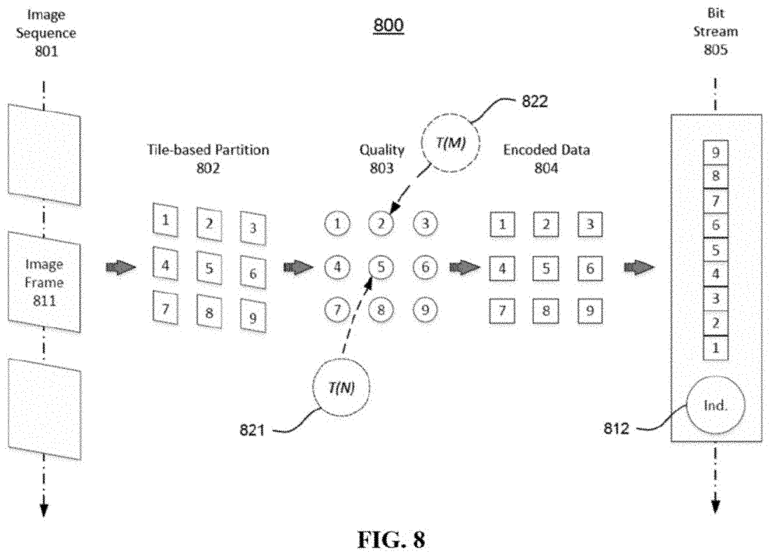

FIG. 8 illustrates supporting bit stream switching in video streaming using tiles, in accordance with various embodiments of the present invention. As shown in FIG. 8, using a tile-based partition scheme 802, an image frame 811 in a sequence of image frames 801 can be partitioned into a plurality of tiles (e.g. tiles 1-9). Furthermore, a streaming controller can determine encoding quality 803 for each tile in the image frame 811. Additionally, the streaming controller can obtain, from the stored bit streams in the server, encoded data 804 with the determined encoding quality for each tile of the image frame 811. Then, the streaming controller can incorporate (e.g. encapsulate) the encoded data 804 for the plurality of sections (e.g. tiles) of the first image frame in a bit stream 805 for transmission, according to a predetermined order. In some instances, the predetermined order can be configured based on relative locations of each particular section (e.g. tile) in the sequence of image frames.

In accordance with various embodiments, the streaming controller can dynamically select the encoded data, from a stored bit stream, for each section (e.g. tile) in an image frame that needs to be transmitted, according to the viewport of the user equipment (UE).

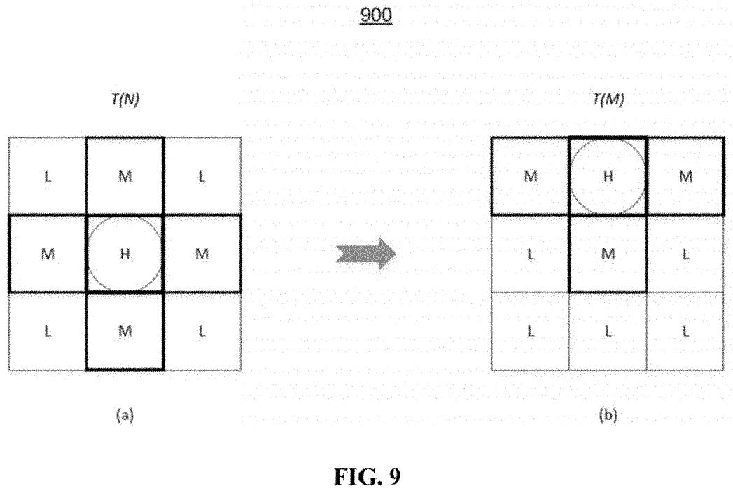

Referring to FIG. 9(a), the tile 5 corresponds to the viewport 821 at the time point, T(N). Thus, the tile 5 may be assigned with a “High” quality (H). Furthermore, each of the titles 2, 4, 6, and 8 can be assigned with a “Medium” quality (M), and each of the tiles 1, 3, 7, and 9 can be assigned with a “Low” quality (L).

After determining the encoding quality corresponding to each of the tiles in the image frame 811, the streaming controller can obtain the encoded data with a desired quality for each tile in the image frame 811 from a corresponding stored bit stream in the server. For example, in the example as shown in FIG. 9(a), the streaming controller can obtain encoded data for tile 5 from a high quality bit stream (e.g. 710 of FIG. 7). Also, the streaming controller can obtain encoded data for tiles 2, 4, 6, and 8 from medium quality bit streams (e.g. 720 of FIG. 7), and the streaming controller can obtain encoded data for tiles 1, 3, 7, and 9 from low quality bit streams (e.g. 730 of FIG. 7).

Then, the streaming controller can encapsulate the obtained encoded data for different tiles into a bit stream 805 for transmission. In various instances, the encoded data for each tile can be encapsulated according to a predetermined order. For example, the predetermined order can be configured based on a raster scanning order, which refers to the order from left to right and top to bottom in the image frame.

In accordance with various embodiments, the video streaming approach based on viewport can effectively reduce the data transmitted for the panoramic or wide view video, while taking into account the subjective experience in viewing. On the other hand, when the viewport changes, i.e. when the human sight moves around, the image section corresponding to the viewport may also change.

In accordance with various embodiments, the streaming controller can dynamically switch among different qualities of bit stream for each partitioned section that are used for generating the bit stream 805 for transmission in video streaming. For example, the streaming controller may receive viewport information at later time point for a second image frame. Here, the viewport information for the second image frame may indicate a location of a viewport for the second image frame. The second image frame follows or trails the first image frame in the sequence of image frames, and the location of the viewport for the first image frame may be different from the location of the viewport for the second image frame.

Referring to FIG. 9(b), at the time point, T(M), the viewport 822 may shift to the tile 2. The streaming controller can adjust the coding quality for each tile in the image frame. As shown in FIG. 9(b), the tile 2 is assigned with a “High” quality (H). Furthermore, the titles 1, 3, and 5 can be assigned with a “Medium” quality (M), and the tiles 4, 6, 7, 8, and 9 can be assigned with a “Low” quality (L).

Thus, the streaming controller can perform bit stream switching at or after the time point, T(M). After determining the encoding quality for each of the tiles in the image frame, the streaming controller can obtain the encoded data with a desired quality for each tile in the image frame from the corresponding stored bit streams in the server. In the example as shown in FIG. 9(b), the streaming controller can obtain encoded data for tile 2 from a high quality bit stream (e.g. 710 of FIG. 7). Additionally, the streaming controller can obtain encoded data for tiles 1, 3, and 5 from medium quality bit streams (e.g. 720 of FIG. 7), and the streaming controller can obtain encoded data for tiles 4, 6, 7, 8, and 9 from low quality bit streams (e.g. 730 of FIG. 7).

In various instances, the bit stream switching can be performed at the random access point. For example, the random access point may be an instantaneous decoding refresh (IDR) picture, a clean random access (CRA) picture, a sequence header, a sequence header+1 frame, etc.

As shown in FIG. 9(b), after a change in the position of the viewport at a time point, T(M), the streaming controller may perform bit stream switching at the first random access point after the time point, T(M). For example, the streaming controller can determine encoding quality for each section in the second image frame based on the received viewport information for the second image frame, if the second image frame is at a random access point to decode the encoded data in the bit stream. Otherwise, the streaming controller can determine encoding quality for each section in the second image frame based on the encoding quality for a corresponding section in the first image frame, if the second image frame is not at a random access point to decode the encoded data in the bit stream. In such a case, the streaming controller can wait and perform bit stream switching until the first random access point after the time point, T(M).

In accordance with various embodiments, using the above scheme, the streaming controller can incorporate encoded data, with different qualities, for different sections in the image frames into a single bit stream 805. Unlike the approach relying on transmitting multiple bit streams, the above scheme can avoid the multi-channel synchronization problem. Thus, the system layer for transmitting the video code stream does not need to perform the synchronization operation, for example, using the system protocols of DASH (Dynamic Adaptive Streaming Over Http), HLS (Http Live Streaming), MPEG TS (Transport Stream). Additionally, the above scheme can avoid the need for combining data from multiple channels at the user equipment, since the location of encoded data for each tile is encapsulated accordingly to the relative location of each tile in the image frame.

Additionally, an indicator 812 can be provided and associated with the bit stream. In accordance with various embodiments, the indicator 812 can indicate that encoding prediction dependency for the particular section of each image frame in the sequence of image frames is constrained within said particular section.

In various embodiment, the indicator 812 provided by an encoder or the streaming controller at the server side can be the same or related to the indicator received by the decoder, i.e., the indicator can indicate both encoding and decoding prediction dependency.

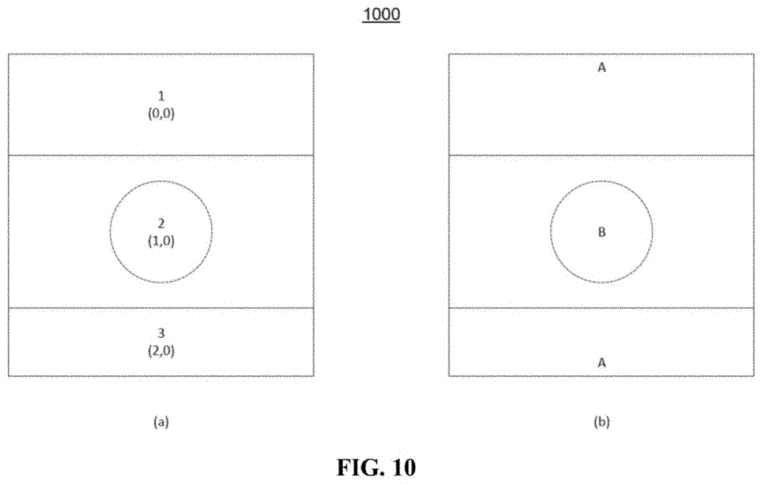

FIG. 10 illustrates exemplary image partition schemes based on slices, in accordance with various embodiments of the present invention. As shown in FIG. 10(a) and FIG. 10(b), a number of slices can be used for partitioning an image frame (or picture) in a video.

In accordance with various embodiments, a slice can be a sequence of slice segments starting with an independent slice segment and containing zero or more subsequent dependent slice segments that precede a next independent slice segment, in each image frame. Alternatively, a slice can be a sequence of coding blocks or a sequence of coding block pairs.

In various instances, slices can be used for video coding. For example, an image frame allows only one slice in the horizontal direction (i.e. the partition cannot be performed in the vertical direction). Data in different slices in the same image frame cannot be cross-referenced and predicted (although filtering operations may be performed crossing the boundaries of different tiles in the same image). The filtering operations include deblocking, sample adaptive offset (SAO), Adaptive Loop Filter (ALF) etc.

In the example as shown in FIG. 10(a), an image can be partitioned into three slices (or regions). Each slice can be encoded with different qualities. In various instances, the coding quality can be defined either quantitatively or qualitatively. For example, the coding quality may be defined as one of “High”, “Medium” or “Low” (each of which may be associated with a quantitative measure). Alternatively or additionally, the coding quality can be represented by numbers, characters, alphanumeric strings, or any other suitable representations. In various instances, the coding quality may refer to various coding objective measures, subjective measures, and different sampling ratios (or resolutions).

As shown in FIG. 10(a), slice 2, i.e. area (1, 0), is covered by the viewport. Thus, the slice 2 may be assigned with a “High” quality. Furthermore, the slices 2 and 3, i.e. the areas (0, 0), and (2, 0), are adjacent to the area (1, 0) corresponding to the viewport. Thus, these areas can be encoded with a “Medium” quality.

Alternatively, in the example as shown in FIG. 10(b), an image can be partitioned into two sections or areas. Each section is encoded with different qualities, and the coding quality may be defined as one of “High”, “Medium” or “Low”. As shown in FIG. 10(b), section B (e.g. a slice) is covered by the viewport. Thus, the section B may be assigned with a “High” quality. Furthermore, section A, which surrounding the section B, may be assigned with a “Low” or “Medium” quality.

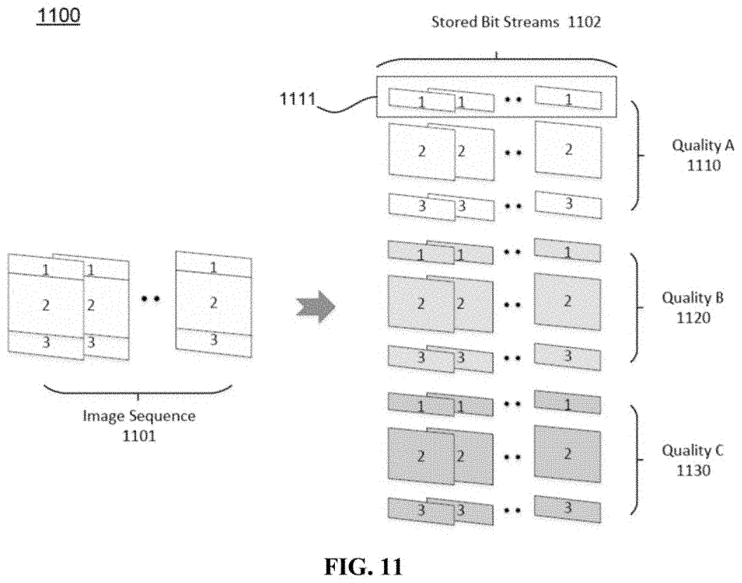

FIG. 11 illustrates encoding an image frame sequence for supporting video streaming, in accordance with various embodiments of the present invention. As shown in FIG. 11, an image sequence 1101 can be encoded and stored as bit streams 1102 in the sever 1100. Here, each bit stream can be provided with a particular quality for a single section on the server side. For example, a stored bit stream 1111 corresponds to encoded data with quality A (e.g. “High”) for section 1 in the image sequence 1101.

As shown in FIG. 11, an image frame in the image sequence 1101 (i.e. the video) can be partitioned into 3 sections, while each section may be encoded with three qualities (e.g. “High”, “Medium” or “Low”). For example, the encoding can be based on various video codec standards, such as H.264/AVC, H.265/HEVC, AVS1-P2, AVS1-P2 and so on.

In accordance with various embodiments, each bit stream is capable of being independent decoded. For example, each bit stream may contain independent video parameter set (VPS) information, independent sequence header information, independent sequence parameter set (SPS) information, independent picture header information, or a separate Picture Parameter Set (PPS) parameter.

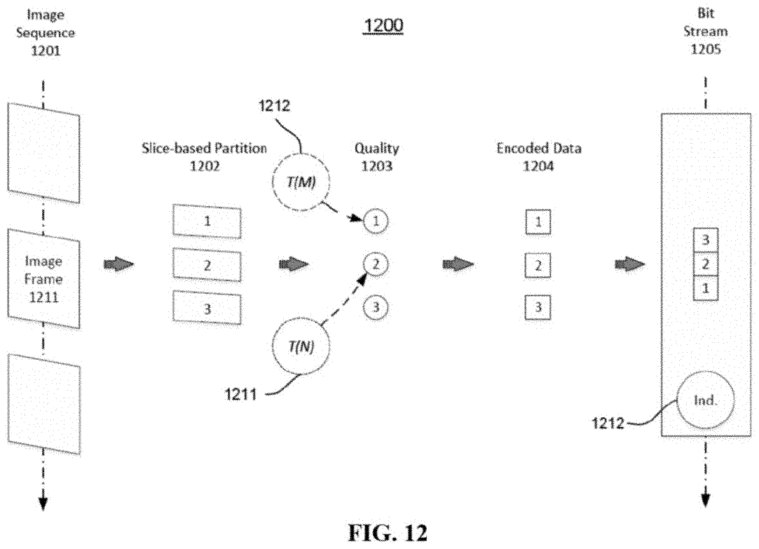

FIG. 12 illustrates supporting bit stream switching in video streaming using slices, in accordance with various embodiments of the present invention. As shown in FIG. 12, using a slice-based partition scheme 1202, an image frame 1211 in a sequence of image frames 1201 can be partitioned into a plurality of slices (e.g. slices 1-3). Furthermore, a streaming controller can determine encoding quality 1203 for each slice in the image frame 1211. Additionally, the streaming controller can obtain, from the stored bit streams in the server, encoded data 1204 with the determined encoding quality for each tile of the image frame 1211. Then, the streaming controller can incorporate (e.g. encapsulate) the encoded data 1204 for the plurality of sections of the first image frame in a bit stream 1205 for transmission, according to a predetermined order. In some instances, the predetermined order can be configured based on relative locations of each particular section (e.g. slice) in the sequence of image frames.

In accordance with various embodiments, the streaming controller can dynamically select the encoded data, from a stored bit stream, for each section in an image frame that needs to be transmitted, according to the viewport of the user equipment (UE).

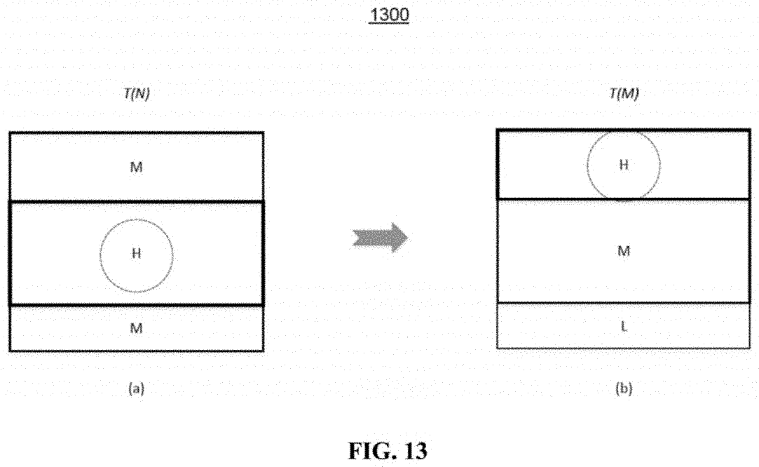

Referring to FIG. 13(a), slice 2, i.e. slice (1, 0), corresponds to the viewport 1211 at the time point, T(N). Thus, the slice 2 may be assigned with a “High” quality (H). Furthermore, each of the slices 1, and 3 can be assigned with a “Medium” quality (M).

After determining the encoding quality corresponding to each of the slices in the image frame 1211, the streaming controller can obtain the encoded data with a desired quality for each slice in the image frame 1211 from a corresponding stored bit stream in the server. For example, in the example as shown in FIG. 13(a), the streaming controller can obtain encoded data for slice 2 from a high quality bit stream (e.g. 1110 of FIG. 11), and the streaming controller can obtain encoded data for slice 1 and 3 from medium quality bit streams (e.g. 1120 of FIG. 11).

Then, the streaming controller can encapsulate the obtained encoded data for different slices into a bit stream 1205 for transmission. In various instances, the encoded data for each slice can be encapsulated according to a predetermined order. For example, the predetermined order can be configured based on a raster scanning order, which refers to the order from top to bottom in the image.

In accordance with various embodiments, the video streaming approach based on viewport can effectively reduce the data transmitted for the 360 degree video or a video having a large FOV, while taking into account the subjective experience in viewing. On the other hand, when the viewport changes, i.e. when the human sight moves around, the image section corresponding to the viewport may also change.

In accordance with various embodiments, the streaming controller can dynamically among different qualities of bit stream for each partitioned section that are used for generating the bit stream 1205 for transmission in video streaming. For example, the streaming controller may receive viewport information for a second image frame. Here, the viewport information for the second image frame may indicate a location of a viewport for the second image frame. The second image frame trails the first image frame in the sequence of image frames, and the location of the viewport for the first image frame is different from the location of the viewport for the second image frame.

Referring to FIG. 13(b), at the time point, T(M), the viewport 1212 may shift to the slice 1, i.e. slice (0, 0). The streaming controller can adjust the coding quality for each slice in the image frame. As shown in FIG. 13(b), slice 1 is assigned with a “High” quality (H). Furthermore, the slice 2 can be assigned with a “Medium” quality (M), and the slice 3 can be assigned with a “Low” quality (L).

Thus, the streaming controller can perform bit stream switching at or after the time point, T(M). After determining the encoding quality corresponding to each of the slices in the image frame, the streaming controller can obtain the encoded data with a desired quality for each slice in the image frame from a corresponding stored bit stream in the server. For example, in the example as shown in FIG. 13(b), the streaming controller can obtain encoded data for slice 1 from a high quality bit stream (e.g. 1110 of FIG. 11). Additionally, the streaming controller can obtain encoded data for slice 2 from a medium quality bit stream (e.g. 1120 of FIG. 11), and the streaming controller can obtain encoded data for slice 3 from a low quality bit stream (e.g. 1130 of FIG. 11).

In various instances, the bit stream switching can be performed at the random access point. For example, the random access point may be an instantaneous decoding refresh (IDR) picture, a clean random access (CRA) picture, a sequence header, a sequence header+1 frame, etc.

As shown in FIG. 13(b), after a change in the position of the viewport at a time point, T(M), the streaming controller may perform bit stream switching at the first random access point after the time point, T(M). For example, the streaming controller can determine encoding quality for each section in the second image frame based on the received viewport information for the second image frame, if the second image frame is a random access point to decode the encoded data in the bit stream. Otherwise, the streaming controller can determine encoding quality for each section in the second image frame based on the encoding quality for a corresponding section in the first image frame, if the second image frame is not a random access point to decode the encoded data in the bit stream. In such a case, the streaming controller can wait and perform bit stream switching until the first random access point after the time point, T(M).

In accordance with various embodiments, using the above scheme, the streaming controller can incorporate encoded data, with different qualities, for different sections in the image frames into a single bit stream 1205. Unlike the approach relying on transmitting multiple bit streams, the above scheme avoids the multi-channel synchronization problem. Thus, the system layer for transmitting the video code stream does not need to perform the synchronization operation, for example, using the system protocols of DASH (Dynamic Adaptive Streaming over Http), HLS (Http Live Streaming), MPEG TS (Transport Stream). Additionally, the above scheme can avoid combining data from multiple channel at the user equipment, since the location of encoded data for each tile is encapsulated accordingly to the relative location of each tile in the image frame.

Additionally, an indicator 1212 can be provided and associated with the bit stream. In accordance with various embodiments, the indicator 1212 can indicate that encoding prediction dependency for the particular section of each image frame in the sequence of image frames is constrained within said particular section.

In various embodiment, the indicator 1212 provided by an encoder or the streaming controller at the server side can be the same or related to the indicator received by the decoder, i.e., the indicator can indicate both encoding and decoding prediction dependency.

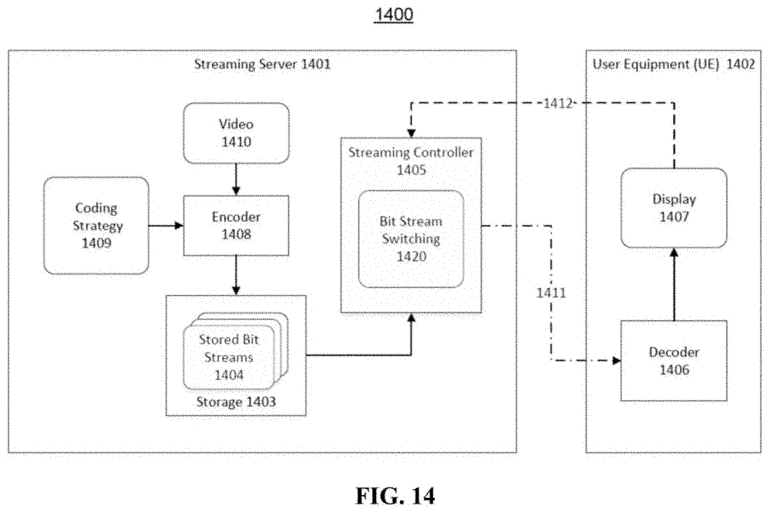

FIG. 14 illustrates an exemplary video streaming environment supporting bit stream switching, in accordance with various embodiments of the present invention. As shown in FIG. 14, a video 1410 can be streamed from server side (e.g. a streaming server 1401) to terminal side (e.g. a user equipment (UE) 1402), in a video streaming environment 1400.

In accordance with various embodiments, at the server side, an encoder 1408 can encode the sequence of image frames in the video 1410 and store various bit streams 1404 with the encoded data into in a storage 1403. The video 1410, e.g. a panoramic or wide view video, may include a sequence of image frames (or pictures) with a large field of view (FOV). Different types of partition schemes may be used for partitioning individual image frame in the video 1410 into a plurality of sections. For example, the partition scheme can partition individual image frame into tiles or slices, or any other geometry divisions that are beneficial in video encoding and decoding.

In various instances, individual image frame in the video 1410 can be partitioned in a same or substantial similar fashion. For example, each image frame in the video 1410 can be partitioned into a same number of sections. Also, corresponding sections in the different image frames may be positioned at the same or substantial similar relative locations and may be configured with same or substantial similar geometry sizes.

In accordance with various embodiments, individual section of the plurality of sections partitioning an image frame can be configured with multiple levels of coding qualities. For example, at the server side, each of the plurality of sections partitioning an image frame can be configured with multiple levels of encoding qualities. At the user equipment (UE) side, each of the plurality of sections partitioning an image frame can be configured with multiple levels of decoding qualities. In various embodiments, the encoding qualities and the decoding qualities may be configured the same or using related predetermined correlations. In other embodiments, the encoding qualities and the decoding qualities may be configured separately and independently.

In accordance with various embodiments, at the server side, the coding quality for individual section in an image frame in the video 1410 can be determined based on user preference information, such as region of interest (ROI) information. Alternatively or additionally, the coding quality for individual section in the image frames can be determined based on viewport information, such as information that indicates the location of a viewport in the image frame. In various embodiments, a section in the image frame corresponding to the viewport can be configured to have a higher level of coding quality than other sections of the image frame that locate outside of the viewport.

In accordance with various embodiments, the encoder 1408 can take advantage of an encoding process as shown in FIG. 1. For example, the encoder 1408 can encode a sequence of image frames in the video 1410 into multiple bit streams with different coding qualities. Various encoding steps can be shared among multiple encoding operations for generating the different bit streams. For example, the encoder 1408 can use the same prediction step 102 and transformation step 103, while employing different quantization steps 104 (e.g. using different quantization parameters) for generating various bit streams with different coding qualities.

As shown in FIG. 14, at the server side, a plurality of bit streams 1404 for the sequence of image frames in the video 1410 can be stored in the storage 1403. In various instances, each individual stored bit stream may contain encoded data with a particular level of coding quality for a particular section in the sequence of image frames.

At the user equipment (UE) side, a decoder 1406 can be used for processing the bit stream 1411 that contains encoded data for the sequence of image frames in the video 1410. The decoder 1406 can decode the binary data in the bit stream 1411 and reconstruct the images frames accordingly, before providing the reconstructed image frames to a display 1407 for displaying or otherwise being viewed by a user (e.g. a viewer). On the other hand, the user equipment (UE) 1402, or a component of the user equipment (UE) 1402 (e.g. the display 1407), can obtain updated user information (e.g. updated viewport information when the user's sight moves around), and provide such updated user information back to the streaming server 1401. Accordingly, the streaming controller 1405 can reconfigure the bit stream 1411, which are transmitted to the user equipment (UE) 1402. For example, the streaming controller 1405 can reconfigure the bit stream 1411 via performing bit stream switching 1420.

In accordance with various embodiments, a streaming controller 1405 can be responsible for controlling the streaming of the video 1410 to the user equipment (UE) 1402. In some instances, the streaming controller 1405 can be an encoder or a component of an encoder. In some instances, the streaming controller 1405 may include an encoder or may function together with an encoder. The streaming controller 1405 can receive user information 1412, e.g. user viewing point information, from the user equipment (UE) 1402. For example, such user viewing point information can include viewport information, which indicates a viewing region by the user. Then, the streaming controller 1405 can create (or direct another component to create) the bit stream 1411, based on the received user information 1412. For example, the bit stream 1411 can be created based on selecting and combining appropriate stored bit streams 1404 in the storage 1403. Then, the bit stream 1411 can be transmitted to the user equipment (UE) 1402 for providing and achieving optimal viewing experience.

In accordance with various embodiments, the streaming controller 1405 can perform bit stream switching 1420 based on the received user information. For example, as a viewer looks around, the received user information 1412 at the server side may indicate a change of the viewport. The streaming controller 1405 can determine the desired coding quality for each section of the images in the stream 1411 accordingly. Then, the streaming controller 1405 can obtain (e.g. select) encoded data with the desired coding quality for various sections in individual image frame, from a stored bit stream in the storage 1403, and incorporate these obtained information into the bit stream 1411 that is transmitted to the UE 1402.

In accordance with various embodiments, in order to eliminate undesirable coding dependency (e.g. inter-frame coding dependency) between an image frame before the bit stream switching 1420 is performed and an image frame after the bit stream switching 1420 is performed, in both the encoder 1408 and decoder 1406, the bit stream switching 1420 can be performed at various switching points that are predetermined or dynamically determined. In various embodiments, these switching points can be the random access points as defined in various codec standards, since the encoding and decoding of the random access point pictures generally do not depend on another image frame. For example, a random access point picture may be an instantaneous decoding refresh (IDR) picture, a clean random access (CRA) picture, a sequence header, a sequence header+1 frame, etc.

In accordance with various embodiments, using the above scheme, the streaming controller 1405 can incorporate encoded data for different sections of the image frames into a bit stream 1411. The encoded data may be configured with different coding qualities (i.e., different sections in an image frame in the bit stream 1411 may have different levels of coding quality). Unlike the approaches relying on transmitting multiple bit streams, the above scheme avoids multi-channel synchronization. For example, the system layer for transmitting the video stream may not need to perform the synchronization operation, e.g., using various system protocols such as Dynamic Adaptive Streaming over HTTP (DASH), HTTP Live Streaming (HLS), MPEG Transport Stream (TS). Additionally, location information for each section in the encoded image frame can be encapsulated according to the relative location of each section in the image frame. Thus, the above scheme can avoid the steps for combining encoded data from multiple channels at the UE 1402.

In accordance with various embodiments, bit stream switching 1420 can be performed at the random access point. For example, the system can select encoded data with a prior coding quality before the random access point and select encoded data with a posterior coding quality after the random access point. Then, the system can incorporate the selected encoded data (including encoded data with a prior coding quality before the random access point and encoded data with a posterior coding quality after the random access point) into the bit stream 1411 that is transmitted to the user equipment (UE) 1402.

In accordance with various embodiments, a random access point may be used for inserting an instantaneous decoding refresh (IDR) picture. In various embodiments, IDR pictures can be encoded based on intra-frame prediction. Hence, the amount of encoded data for an IDR picture may be much larger than the amount of encoded data for an image frame encoded using inter-frame prediction (e.g. an image frame that is prior to or following an inserted IDR picture). Moreover, an exemplary bit stream switching approach may require all areas or sections in the image frames, which may be partitioned according to the viewing angles, to perform bit stream switching at the same time (i.e., all the areas or sections may rely on intra-frame prediction for coding at the same time, as the viewing point changes). As a result, the amount of the bit stream data required for performing the bit stream switching may be substantial larger than the amount of the bit stream data immediately before the switching. It may cause a significant delay to display the IDR picture, since a large amount of stream data need to be transmitted to the display, e.g. via a steady (or constant) channel. Thus, after the viewer changes the viewing point, it may take a significant amount of time for the system to switch the right bit stream to each corresponding viewpoint, which can negatively affect the viewing experience.

Furthermore, after the viewer changes the viewpoint, the bit stream switching 1420 may be performed when the next IDR picture in the video 1410 arrives. At the server side, the IDR frames may be inserted periodically (e.g. with a pre-configured or dynamically determined time interval) to accommodate for the viewpoint change that may occur at any time. Such time interval may have significant influence on overall system performance and user viewing experience. If the time interval between the IDR image insertions is short, then the bit stream switching may be performed frequently. Consequentially, the compressed video code stream may have a relatively large size. If the time interval between the IDR image insertions is long, the data amount of the compressed video code stream may be reduced, but it may cause a significant delay until the corresponding IDR image code stream can be switched when the user changes the viewpoint, which may negatively affect the user experience.

In accordance with various embodiments, a distributed IDR picture transmission technique can be employed for reducing the delay, which is caused by the increase of amount of data for transmitting the IDR image due to performing bit stream switching. As shown in FIG. 14, at the server side, the system can employ various coding strategy 1409 for supporting the distributed IDR image transfer technique. For example, the encoder 1408 can be configured to encode different regions or sections of the IDR picture at different time points (or frames), so that the maximum amount of data transmitted can be reduced. Thus, the system can reduce the significant delay at the various transmission bottleneck points. Additionally, the IDR picture insertion cycles (or periods) can be configured, according to the importance of different regions, to further reduce the amount of data generated for the corresponding regions of certain viewpoints. Also, the IDR picture insertion cycle can be configured to guide the user's attention (i.e. viewing point), in order to convey the content according exactly to the video producer's intention.

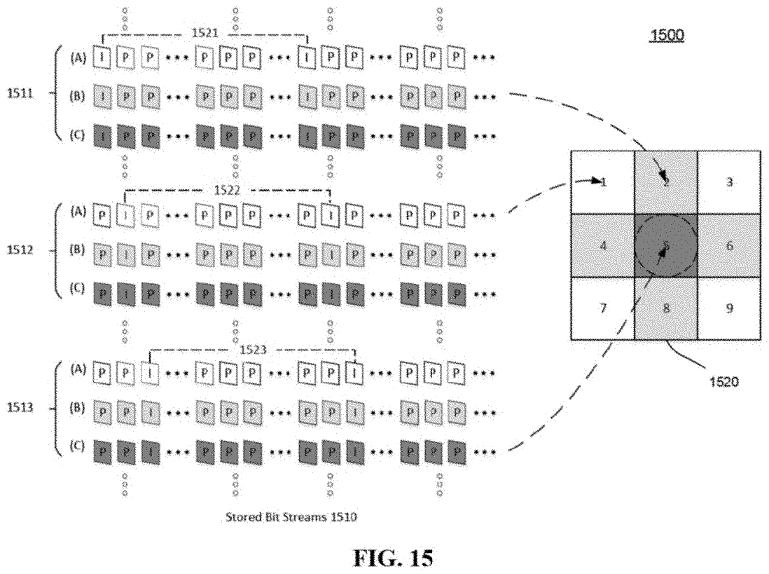

FIG. 15 illustrates supporting distributive IDR picture transmitting in video streaming based on tiles, in accordance with various embodiments of the present invention. As shown in FIG. 15, individual image frame 1520 in a video stream may be partitioned into a plurality of sections, such as regions. For example, each region can comprise one or more tiles according to various video codec standards. In various embodiments, each region in the image frame 1520 may correspond to multiple bit streams with different coding qualities.

In accordance with various embodiments, the stored bit streams 1510 can comprise various bit stream groups that correspond to different regions. As shown in FIG. 15, different regions in the image frame 1520 can be associated with different bit stream groups. For example, the tile 1 in the image frame 1520 can be associated with a bit stream group 1512; tile 2 in the image frame 1520 can be associated with a bit stream group 1511; and tile 5 in the image frame 1520 can be associated with a bit stream group 1513. Each of the bit stream groups, e.g. bit stream groups 1511-1513, may comprise various bit streams with different coding qualities, e.g. High (C), Medium (B), and Low (A). Also each of the bit stream groups, e.g. bit stream groups 1511-1513, may comprise IDR pictures, which may be inserted periodically at various random access points.

In accordance with various embodiments, the system can configure different IDR picture insertion cycles for different regions. The IDR picture insertion cycle associated with a region may be configured for inserting a corresponding IDR picture portion with a particular interval, which may be predetermined or dynamically determined. For example, the bit stream group 1511, which corresponds to the tile 2, may be configured using a first interval 1521; the bit stream group 1512, which corresponds to the tile 1, may be configured using a second interval 1522; and the bit stream group 1513, which corresponds to the tile 5, may be configured using a third interval 1523. Additionally, there may be more bit stream groups corresponding to various other regions in the image frame 1520.

In accordance with various embodiments, corresponding IDR picture portions for different regions can be configured to be inserted at different time points (or frames). As shown in FIG. 15, the IDR picture insertion cycles 1521-1523 for different regions can be configured differently (e.g. with an offset from each other), so that the IDR picture insertion may be performed for no more than one region at any given moment. In other words, when a bit stream switching operation for a region is performed, the system can ensure that, at any given moment, only a portion of the IDR picture corresponding to the particular region may be transmitted in the bit stream, and the encoded data in the stream corresponding to the other regions are portions of non-IDR images (i.e. images coded using inter-frame prediction). Thus, the system can greatly reduce the amount of transmitted data at bottleneck points.

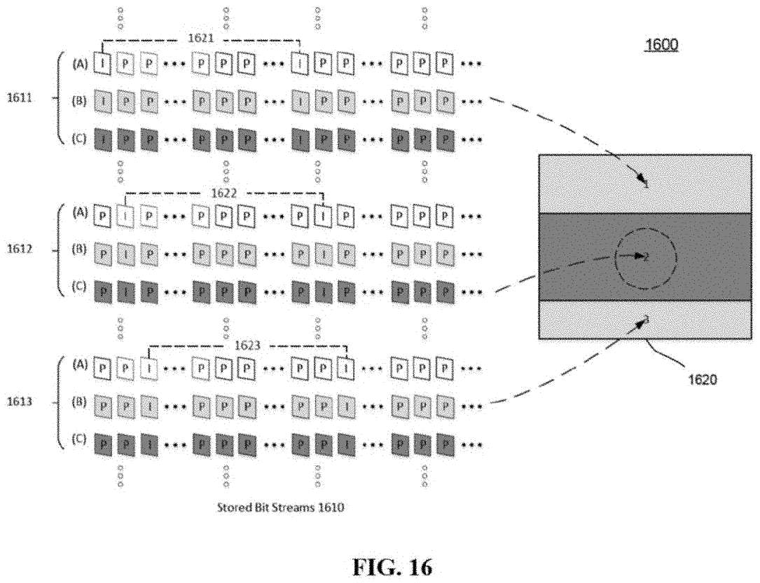

FIG. 16 illustrates supporting distributive IDR picture transmitting in video streaming based on slices, in accordance with various embodiments of the present invention. As shown in FIG. 16, individual image frame 1620 in a video stream may be partitioned into a plurality of sections, such as regions. For example, each region can comprise one or more slices according to various video codec standards. In various embodiments, each region in the image frame 1620 may correspond to multiple bit streams with different coding qualities.

In accordance with various embodiments, the stored bit streams 1610 can comprise various bit stream groups that correspond to different regions. As shown in FIG. 16, different regions in the image frame 1620 can be associated with different bit stream groups. For example, slice 1 in the image frame 1620 can be associated with a bit stream group 1611; slice 2 in the image frame 1620 can be associated with a bit stream group 1612; and slice 3 in the image frame 1620 can be associated with a bit stream group 1613. Each of the bit stream groups, e.g. bit stream groups 1611-1613, may comprise bit streams with different coding qualities, e.g. High (C), Medium (B), and Low (A). Also each of the bit stream groups, e.g. bit stream groups 1611-1613, may comprise (or be inserted with) IDR pictures, which appear periodically at various random access points.

In accordance with various embodiments, the system can configure different IDR picture insertion cycles for different regions. Each DR picture insertion cycle associated with a particular region may be configured with an interval for inserting a corresponding portion of IDR picture. As shown in FIG. 16, the bit stream group 1611, which corresponds to the slice 1, may be configured using a first interval 1621; the bit stream group 1612, which corresponds to the slice 2, may be configured using a second interval 1622; and the bit stream group 1613, which corresponds to the slice 3, may be configured using a third interval 1623. Additionally, there may be more bit stream groups corresponding to various other regions (not shown) in the image frame 1620.

In accordance with various embodiments, the inserting of corresponding portions of IDR picture for different regions can be configured to occur at different time points (or frames). As shown in FIG. 16, the DR picture insertion cycles 1621-1623 for different regions are offsetting from each other, so that the IDR picture insertion may be performed on a limited number of regions (such as no more than one region) at any given moment. In other words, when a bit stream switching operation for a region is performed, the system can be ensured that, at any given moment, only a portion of the IDR picture corresponding to the particular region may be transmitted in the bit stream, and the encoded data in the stream corresponding to the other regions are portions of non-IDR images (i.e. images coded using inter-frame prediction). Thus, the system can greatly reduce the amount of transmitted data at bottleneck points.

In accordance with various embodiments, a progressive bit stream switching technique can be employed. For example, the progressive bit stream switching technique may be employed along with the distributed IDR picture transmitting technique. The system can configure the IDR picture insertion cycles differently for different regions, in order to achieve optimal bandwidth allocation among different regions. In one example, different regions can be assigned with different importance ratings, which can be used as reference for setting the IDR picture insertion cycles for different regions. In another example, the progressive bit stream switching technology can set the importance rating according to the intention of the video producer, in order to direct the attention of the viewer according to the video producer's intention.

In accordance with various embodiments, the IDR picture insertion cycle can be configured differently for different regions in the image, in order to control the cycle for refreshing the image data in decoding process, which in turn affects the amount of coded bit stream data that need to be transmitted for each region. Hence, the shorter an IDR picture insertion cycle is, more images are encoded using the intra-frame prediction, and as a result the encoding process may generate a large amount of code stream data. In accordance with various embodiments, the allocation of bandwidth for different regions can be controlled according to the period for inserting the IDR pictures. For example, it is preferable that a more important area is allowed to consume more bandwidth than a less important area. Thus, an important area may be set with a shorter IDR image insertion period so that when the user changes the viewing point from a less important area to a more important area, the important area can be quickly switched to image with a high coding quality.

In accordance with various embodiments, the progressive code stream switching technology can ensure smooth data stream transmission even when the bit stream switching happens. The bit streams for different regions can be switched in a progressive manner, which ensures that the impact on the transmission bandwidth at any given time are under control.

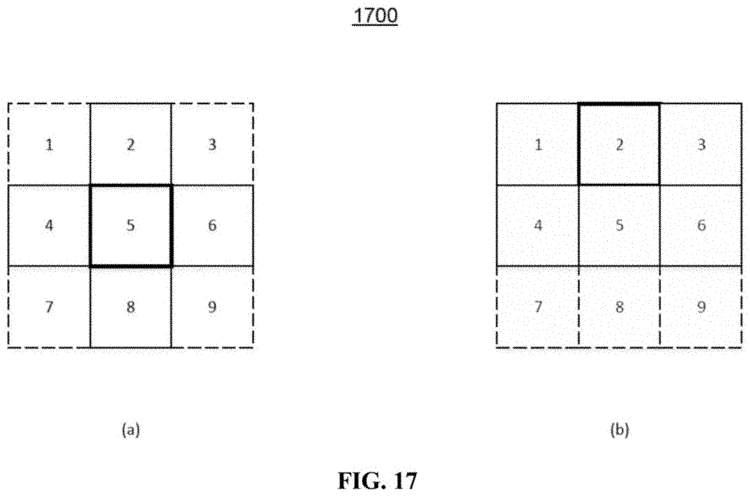

FIG. 17 illustrates configuring IDR picture insertion cycle based on importance ratings associated with different tiles, in accordance with various embodiments of the present invention. As shown in FIG. 17(a)-(b), an image frame can be divided into multiple sections (e.g. tiles 1-9). The different sections can be configured or assigned with different importance ratings.

In the example as shown in FIG. 17(a), the front or central area in a panoramic or wide-angle view (e.g. the tile 5) can be configured with a high importance rating. On the other hand, the rear or peripheral area (e.g. the tiles 1, 3, 7, and 9) can be configured with a low importance rating. Additionally, the other area (e.g. the tiles 3, 4, 6, and 8) can be configured with a medium importance rating. Correspondently, each of the tiles 1-9 can be configured with an IDR picture insertion cycle based on the importance rating. For example, the tile 5 can be configured with the shortest IDR picture insertion cycle; the tiles 1, 3, 7, and 9 can be configured with the longest IDR picture insertion cycle; and the tiles 3, 4, 6, and 8) can be configured with medium IDR picture insertion cycle.

In the example as shown in FIG. 17(b), a video producer may want to direct a viewer's attention to the upper half of the video. Thus, the tile 2 can be configured with a high importance rating. Also, the surrounding areas (e.g. the tiles 1, 3, 4, 5, and 6) can be configured with a medium importance rating. Additionally, the bottom portion (e.g. the tiles 7, 8, and 9) can be configured with a low importance rating. Correspondently, each of the tiles 1-9 can be configured with an DR image insertion period based on the importance rating. For example, the tile 2 can be configured with the shortest IDR picture insertion cycle; the tiles 1, 3, 4, 5, and 6 can be configured with the longest IDR picture insertion cycle; and the tiles 7, 8, and 9 can be configured with medium IDR picture insertion cycle.

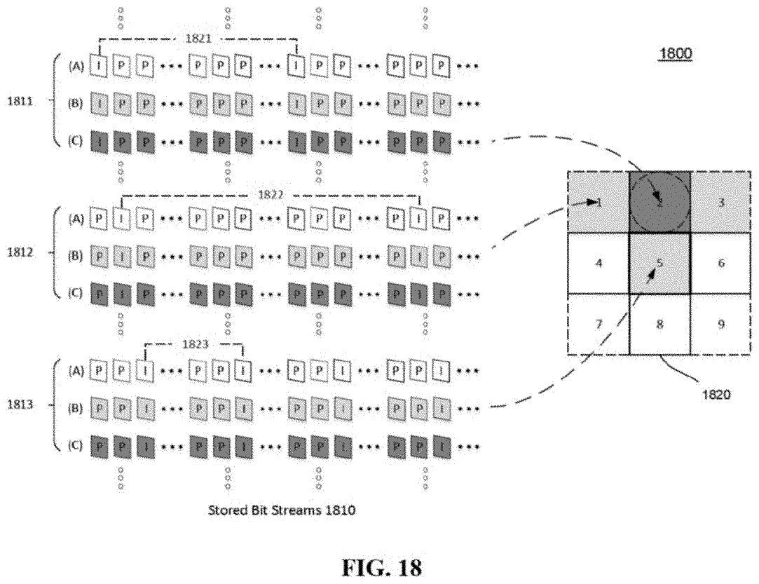

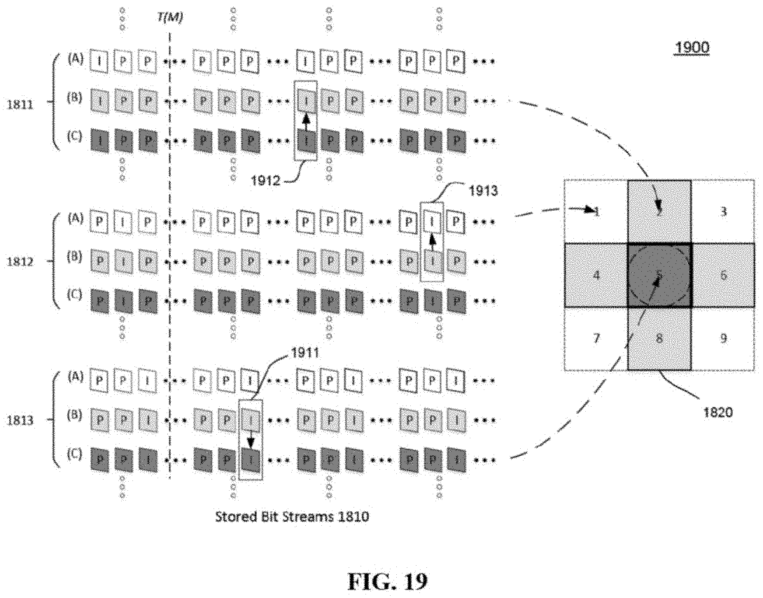

FIGS. 18-19 illustrates performing bit stream switching at the server side based on the exemplary configuration as shown in FIG. 17(a). For example, the tile 5 can be configured with the shortest DR picture insertion cycle; the tiles 1, 3, 7, and 9 can be configured with the longest DR picture insertion cycle; and the tiles 2, 4, 6, and 8 can be configured with a medium IDR picture insertion cycle.

In accordance with various embodiments, the stored bit streams 1810 can comprise various bit stream groups that correspond to different tiles. Different tiles in the image frame 1820 can be associated with different bit stream groups. For example, the tile 1 in the image frame 1820 can be associated with a bit stream group 1812; the tile 2 in the image frame 1820 can be associated with a bit stream group 1811; and the tile 5 in the image frame 1820 can be associated with a bit stream group 1813. Each of the bit stream groups, e.g. bit stream groups 1811-1813, may comprise bit streams with different coding qualities, e.g. High (C), Medium (B), and Low (A). Also each of the bit stream groups, e.g. bit stream groups 1811-1813, may comprise (or be inserted with) IDR pictures, which appear periodically at various random access points.

As shown in FIG. 18, a viewport may initially locate at the tile 2 (e.g. when the user is focusing on top portion of the view). Thus, the encoded data with high coding quality can be selected (e.g. from the storage) for displaying at the tile 2. Additionally, encoded data with medium coding quality can be selected for the tiles 1, 3, and 5; and encoded data with medium coding quality can be selected for the tiles 4, 6, 7, 8, and 9.

Then, as shown in FIG. 19, an event may happen at the moment T(M), which triggers bit stream switching. For example, as the viewing point moves from the tile 2 to the tile 5, e.g. when the viewer moves the viewport from the top portion of the view to the front portion of the view, the system may update the coding quality for each tile accordingly.

Using the distributed IDR image transmission technique, the bit stream switching may be performed separately for different tiles. In various embodiments, the bit stream switching may be performed for each tile in the order that corresponding portion of the IDR picture for each respective tile arrives. In the example as shown in FIG. 19, the IDR picture portion for the tile 5 arrives first, then the system can perform bit stream switching 1911 for the tile 5 before other tiles. Following the order of the arrival of IDR picture portions, the system can perform the bit stream switching progressively for the other regions. For example, the IDR picture portion for the tile 2 arrives before the IDR picture portion for the tile 1. Then, the bit stream switching 1913 for the tile 2 may be performed before the bit stream switching 1912 for the tile 1, but after the bit stream switching 1911 for the tile 5. As the result of bit stream switching, the encoded data with high coding quality can be selected for the tile 5; encoded data with medium coding quality can be selected for regions 2, 4, 6 and 8; and encoded data with medium coding quality can be selected for the regions 1, 3, 7, and 9, which optimize the viewing experience.

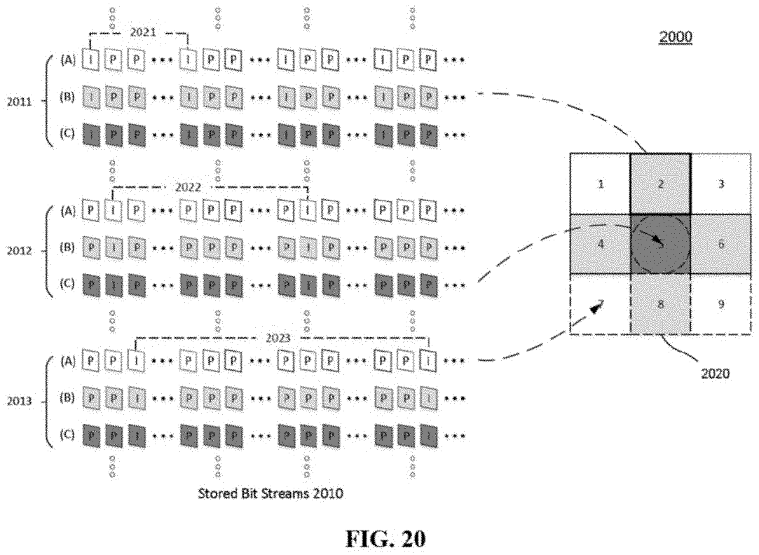

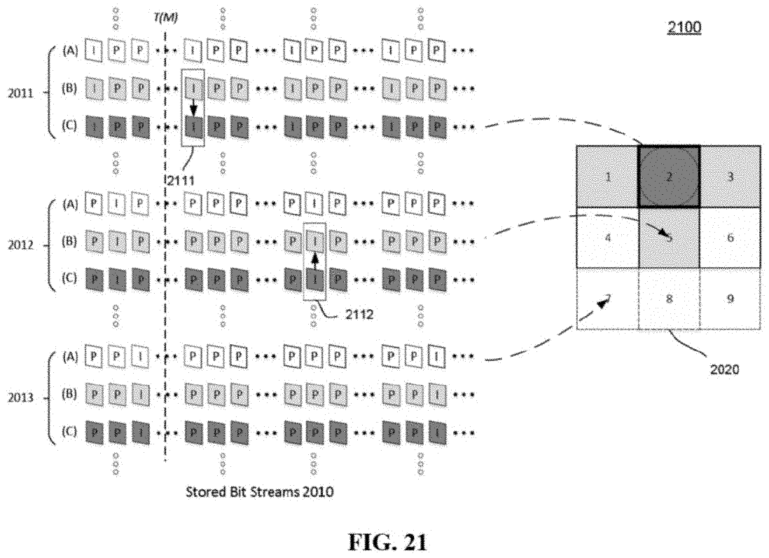

FIGS. 20-21 illustrates performing bit stream switching at the server side based on the exemplary configuration as shown in FIG. 17(b). For example, the tile 2 can be configured with the shortest DR picture insertion cycle; the tiles 1, 3, 4, 5, and 6 can be configured with a medium DR picture insertion cycle; and the tiles 7, 8, and 9 can be configured with the longest DR picture insertion cycle.

In accordance with various embodiments, the stored bit streams 2010 can comprise various bit stream groups that correspond to different tiles. Different tiles in the image frame 2020 can be associated with different bit stream groups. For example, the tile 1 in the image frame 2020 can be associated with a bit stream group 2012; the tile 2 in the image frame 2020 can be associated with a bit stream group 2011; and the tile 5 in the image frame 2020 can be associated with a bit stream group 2013. Each of the bit stream groups, e.g. bit stream groups 2011-2013, may comprise bit streams with different coding qualities, e.g. High (C), Medium (B), and Low (A). Also each of the bit stream groups, e.g. bit stream groups 2011-2013, may comprise (or be inserted with) IDR pictures, which appear periodically at various random access points.

As shown in FIG. 20, a viewport may initially locate at the tile 5 (e.g. when the user is focusing on the front portion of the view), then the encoded data with high coding quality can be selected (e.g. from the storage) for displaying at the tile 5. Additionally, encoded data with medium coding quality can be selected for the tiles 2, 4, 6, and 8; and encoded data with low coding quality can be selected for the tiles 1, 3, 7, and 9.

As shown in FIG. 21, an event may happen at the moment T(M), which triggers the bit stream switching. For example, as the viewing point moves from the tile 5 to the tile 2, e.g. when the viewer moves the viewport from the front portion of the view to the top portion of the view as intended by the video producer, the system may update the coding quality for each tile accordingly.

Using the distributed IDR image transmission technique, the bit stream switching may be performed separately for different tiles. As shown in FIG. 21, the bit stream switching may be performed for each tile in the order that respective portion of the IDR picture for each tile arrives. In the example as shown in FIG. 21, the IDR picture portion for the tile 2 arrives first, then the system can perform the bit stream switching 2111 for the tile 2 before other tiles. Following the order of the arrival of IDR picture portions, the system can perform the bit stream switching progressively for the other regions. For example, the IDR picture portion for the tile 5 arrives after the IDR picture portion for the tile 2. Then, the bit stream switching 2112 for the tile 5 may be performed after the bit stream switching 2111 for the tile 2. Additionally, no bit stream switching needs to be performed for the tile 7 since there is no change of coding quality in the tile 7. As the result of bit stream switching, encoded data with high coding quality can be selected for the tile 2; encoded data with medium coding quality can be selected for the tiles 1, 3, 4, 5 and 6; and encoded data with medium coding quality can be selected for the tiles 7, 8, and 9, which optimize the viewing experience.

As illustrated in the above examples, using the progressive bit stream switching technique along with the distributed IDR image transmitting technique, the system can reduce the maximum bandwidth for performing bit stream switching, while allowing the region with high importance to be refreshed promptly without significant delay to improve viewing experience.

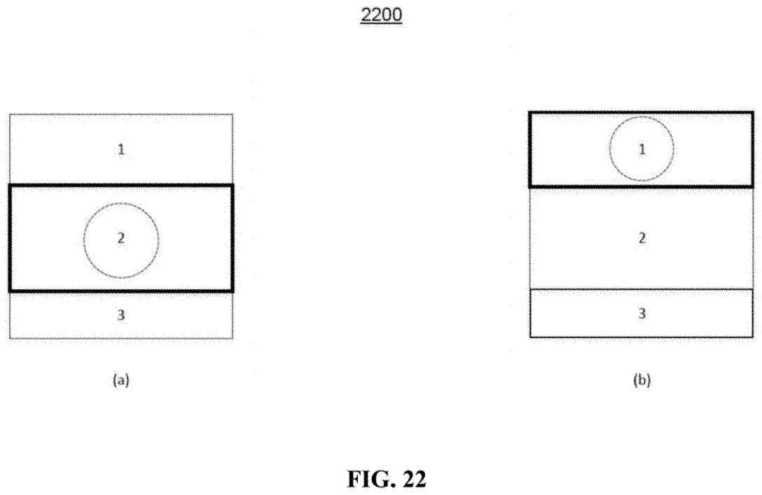

FIG. 22 illustrates configuring IDR picture insertion cycle based on importance ratings associated with different slices, in accordance with various embodiments of the present invention. As shown in FIG. 22, an image frame can be divided into multiple sections, e.g. the slices 1-3. The different sections can be assigned with different importance ratings.

In the example as shown in FIG. 22(a), the central area in a panoramic or wide-angle view (e.g. slice 2) can be configured with a higher importance rating. On the other hand, the top and bottom area (e.g. the slices 1 and 3) can be configured with a lower importance rating. Correspondently, each of the slices 1-3 can be configured with an IDR picture insertion cycle based on the importance rating. For example, the slice 2 can be configured with the shortest IDR picture insertion cycle; and the slices 1 and 3 can be configured with longer IDR picture insertion cycles.

In the example as shown in FIG. 22(b), a video producer may want to direct a viewer's attention to the top half of the video. Thus, the slice 1 can be configured with a higher importance rating. On the other hand, rest of the areas (e.g. the slices 2 and 3) can be configured with a lower importance rating. Correspondently, each of the slices 1-3 can be configured with an IDR image insertion period based on the importance rating. For example, the slice 1 can be configured with the shortest IDR picture insertion cycle; and the slices 2 and 3 can be configured with longer IDR picture insertion cycles.

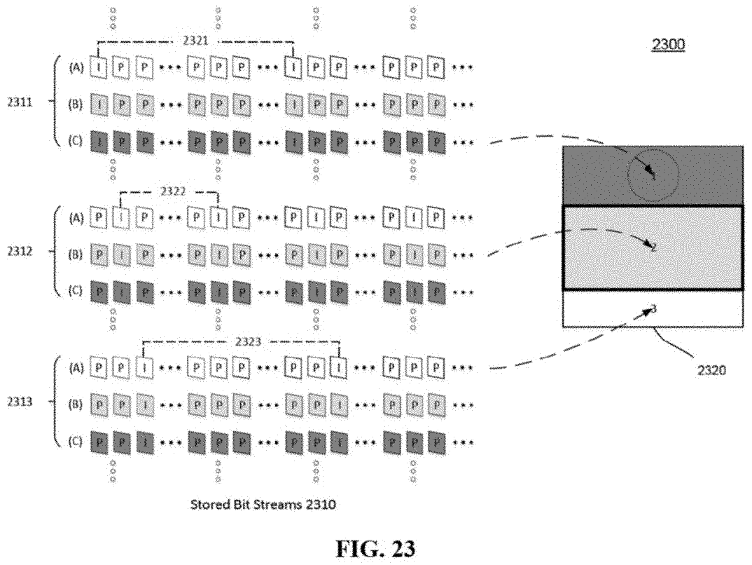

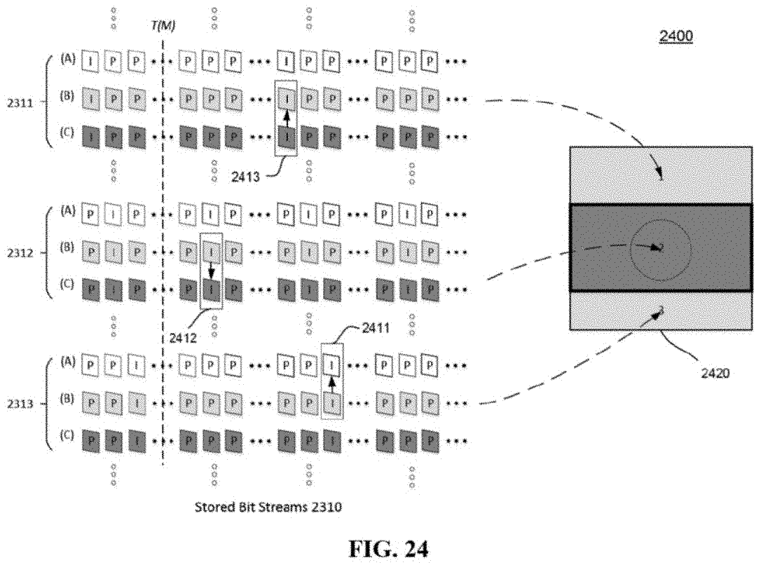

FIGS. 23-24 illustrates performing bit stream switching at the server side based on the exemplary configuration as shown in FIG. 22(a). For example, the slice 2 can be configured with the shortest IDR picture insertion cycle; and the slices 1 and 3 can be configured with longer IDR picture insertion cycles.

In accordance with various embodiments, the stored bit streams 2310 can comprise various bit stream groups that correspond to different tiles. Different slices in the image frame 2320 can be associated with different bit stream groups. For example, the slice 1 in the image frame 2320 can be associated with a bit stream group 2312; the slice 2 in the image frame 2320 can be associated with a bit stream group 2311; and the slice 3 in the image frame 2320 can be associated with a bit stream group 2313. Each of the bit stream groups, e.g. bit stream groups 2311-2313, may comprise bit streams with different coding qualities, e.g. High (C), Medium (B), and Low (A). Also each of the bit stream groups, e.g. bit stream groups 2311-2313, may comprise (or be inserted with) IDR pictures, which appear periodically at various random access points.

As shown in FIG. 23, a viewport may initially locate at the slice 1 (e.g. when the user is focusing on the top portion of the view). Thus, the encoded data with high coding quality can be selected (e.g. from the storage) for displaying at the slice 1. Additionally, encoded data with lower coding quality can be selected for the slices 2 and 3.

As shown in FIG. 24, an event may happen at the moment T(M), which triggers bit stream switching. For example, as the viewing point moves from the slice 1 to the slice 2, e.g. when the viewer moves the viewport from the top portion of the view to the central portion of the view, the system may update the coding quality for each slice accordingly.

Using the distributed IDR image transmission technique, the bit stream switching may be performed separately for different slices. As shown in FIG. 24, the bit stream switching may be performed for each slice in the order that respective portion of the IDR picture for each slice arrives. For example, the IDR picture portion for the slice 2 arrives first, then the system can perform bit stream switching 2412 for the slice 2 before other slices. Then, following the order of the arrival of other IDR picture portions, the system can perform the bit stream switching progressively for the other regions. For example, the IDR picture portion for the slice 1 arrives before the IDR picture portion for the slice 3. Then, the bit stream switching 2413 for the slice 1 may be performed before the bit stream switching 2411 for the slice 3, but after the bit stream switching 2412 for the slice 2. Thus, as the result of bit stream switching, the encoded data with high coding quality can be selected for the slice 2; and encoded data with lower coding quality can be selected for the slices 1, and 3, which optimize the viewing experience.

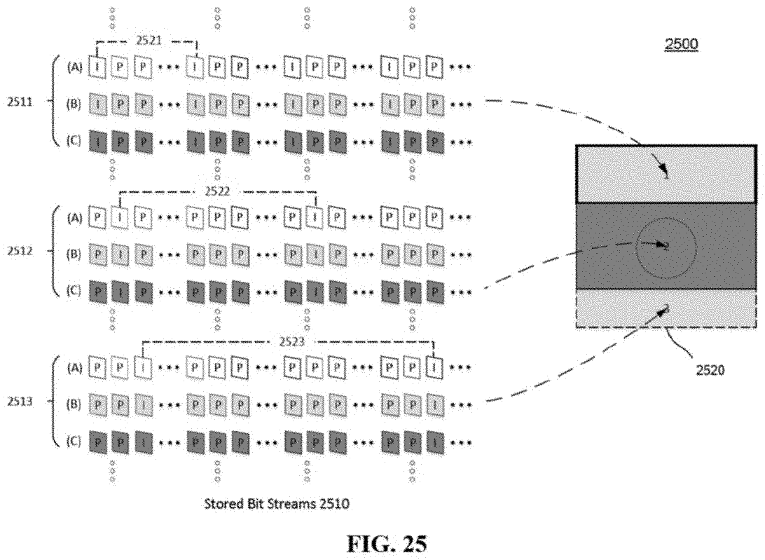

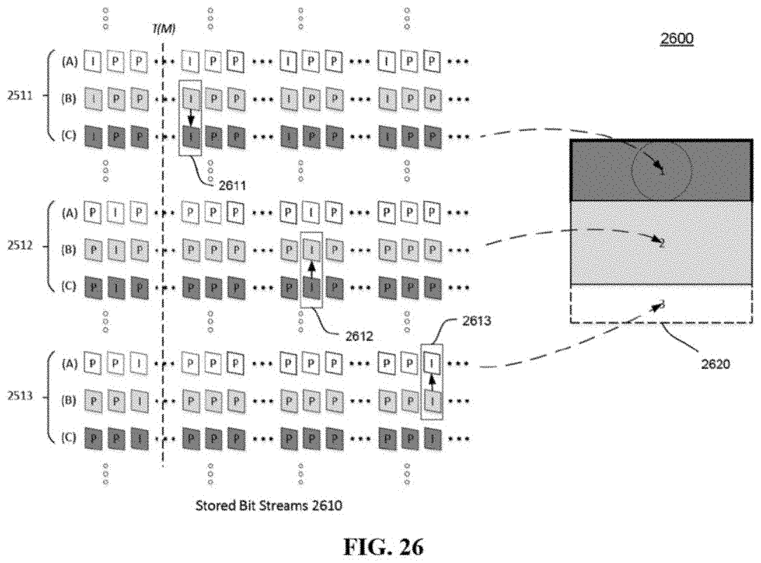

FIGS. 25-26 illustrates performing bit stream switching at the server side based on the exemplary configuration as shown in FIG. 22(b). For example, the slice 1 can be configured with the shortest IDR picture insertion cycle; and slices 2, and 3 can be configured with a longer IDR picture insertion cycle.

In accordance with various embodiments, the stored bit streams 2510 can comprise various bit stream groups that correspond to different tiles. Different slices in the image frame 2520 can be associated with different bit stream groups. For example, the slice 1 in the image frame 2520 can be associated with a bit stream group 2512; the slice 2 in the image frame 2520 can be associated with a bit stream group 2511; and slice 3 in the image frame 2520 can be associated with a bit stream group 2513. Each of the bit stream groups, e.g. bit stream groups 2511-2513, may comprise bit streams with different coding qualities, e.g. High (C), Medium (B), and Low (A). Also each of the bit stream groups, e.g. bit stream groups 2511-2513, may comprise (or be inserted with) IDR pictures, which appear periodically at various random access points.

As shown in FIG. 25, a viewport may initially locate at the slice 2 (e.g. when the user is focusing on the front portion of the view). Thus, the encoded data with high coding quality can be selected (e.g. from the storage) for displaying at the slice 2. Additionally, encoded data with lower coding quality can be selected for the slices 1, and 3.

Then, as shown in FIG. 26, an event may happen at the moment T(M), which triggers bit stream switching. For example, as the viewing point moves from the slice 2 to the slice 1, e.g. when the viewer moves the viewport from the front portion of the view to the top portion of the view as intended by the video producer, the system may update the coding quality for each slice accordingly.

Using the distributed IDR image transmission technique, the bit stream switching may be performed separately for different slices. As shown in FIG. 26, bit stream switching may be performed for individual slice in the order that respective portion of the IDR picture arrives. In the example as shown in FIG. 26, the IDR picture portion for the slice 1 arrives first, then the system can perform the bit stream switching 2611 for the slice 1 before other tiles. Following the order of the arrival of IDR picture portions, the system can perform the bit stream switching progressively for the other regions. For example, the IDR picture portion for the slice 2 arrives after the IDR picture portion for the slice 1. Then, the bit stream switching 2112 for the slice 2 may be performed after the bit stream switching 2111 for slice 1. Additionally, no bit stream switching needs to be performed for the slice 7 since there is no change of coding quality in the slice 3. As the result of bit stream switching, the encoded data with high coding quality can be selected for the slice 1; and encoded data with a lower coding quality can be selected for the slices 2, and 3, which optimizes the viewing experience.

As illustrated in the above examples, using the progressive bit stream switching technique along with the distributed IDR image transmitting technique, the system can reduce the maximum bandwidth for performing bit stream switching, while allowing the region with high importance to be refreshed promptly without significant delay to improve viewing experience.

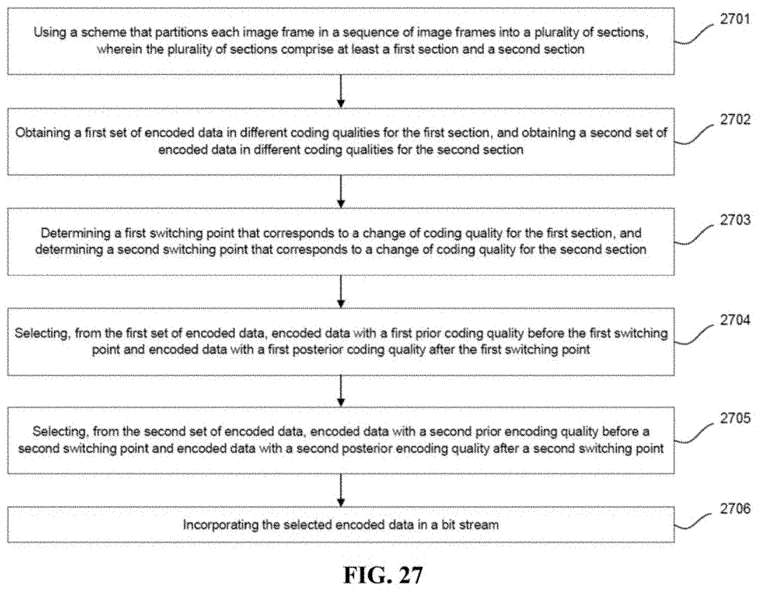

FIG. 27 illustrates a flow chart for supporting bit stream switching in video streaming, in accordance with various embodiments of the present invention. As shown in FIG. 27, at step 2701, the system can use a scheme that partitions each image frame in a sequence of image frames into a plurality of sections, wherein the plurality of sections comprise at least a first section and a second section. At step 2702, the system can obtain a first set of encoded data in different coding qualities for the first section, and can obtain a second set of encoded data in different coding qualities for the second section. At step 2703, the system can determine a first switching point that corresponds to a change of coding quality for the first section, and determining a second switching point that corresponds to a change of coding quality for the second section. At step 2704, the system can select, from the first set of encoded data, encoded data with a first prior coding quality before the first switching point and encoded data with a first posterior coding quality after the first switching point. At step 2705, the system can select, from the second set of encoded data, encoded data with a second prior encoding quality before a second switching point and encoded data with a second posterior encoding quality after a second switching point. At step 2705, the system can incorporate the selected encoded data in a bit stream.

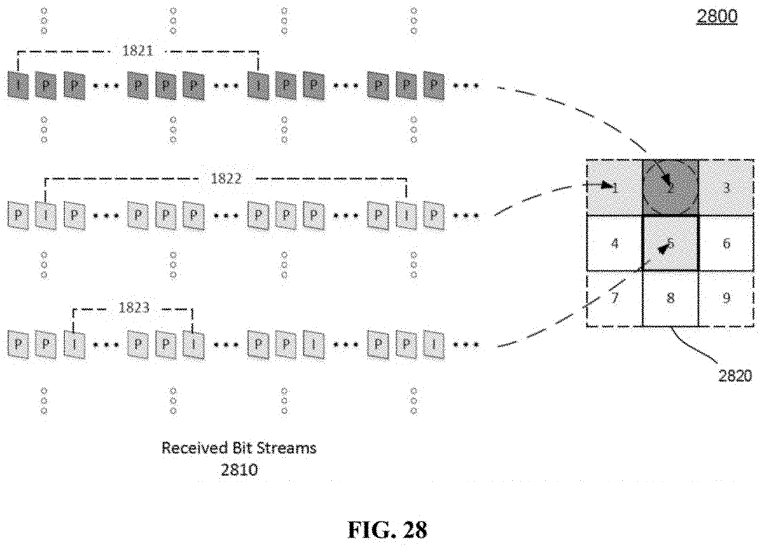

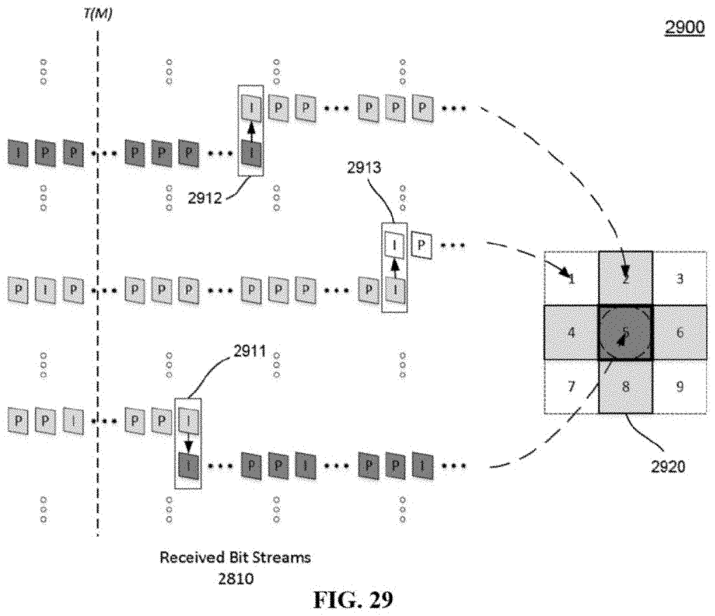

FIGS. 28-29 illustrates performing bit stream switching at the terminal side based on the exemplary configuration as shown in FIG. 17(a). For example, the tile 5 can be configured with the shortest IDR picture insertion cycle; the tiles 1, 3, 7, and 9 can be configured with the longest IDR picture insertion cycle; and the tiles 2, 4, 6, and 8 can be configured with a medium IDR picture insertion cycle.

As shown in FIG. 28, a viewport may initially locate at the tile 2 (e.g. when the user is focusing on top portion of the view). Thus, the binary data with high coding quality may be received (e.g. from the streaming server) at the tile 2, for displaying. Additionally, binary data with medium coding quality may be received for the tiles 1, 3, and 5; and binary data with medium coding quality may be received for the tiles 4, 6, 7, 8, and 9.

As shown in FIG. 29, an event may happen at the moment T(M), which triggers bit stream switching. For example, as the viewing point moves from the tile 2 to the tile 5 (e.g. when the viewer moves the viewport from the top portion of the view to the front portion of the view), the system may update the coding quality for each tile accordingly.

Using the distributed IDR image transmission technique, the bit stream switching may be performed separately for different tiles. In various embodiments, the bit stream switching may be performed for the tiles in the order that respective portion of the IDR picture for each tile arrives. In the example as shown in FIG. 29, the IDR picture portion for the tile 5 arrives first, then the system can perform the bit stream switching 2911 for the tile 5 before other tiles. Then, following the order of the arrival of IDR picture portions, the system can perform the bit stream switching progressively for the other regions. For example, the IDR picture portion for the tile 2 arrives before the IDR picture portion for the tile 1. Then, the bit stream switching 2913 for tile 2 may be performed before the bit stream switching 2912 for tile 1, but after the bit stream switching 2911 for the tile 5. Thus, as the result of bit stream switching and decoding, image data with high coding quality can be displayed for the tile 5; image data with medium coding quality can be displayed for the tiles 2, 4, 6 and 8; and image data with low coding quality can be selected for the tiles 1, 3, 7, and 9, which optimize the viewing experience.

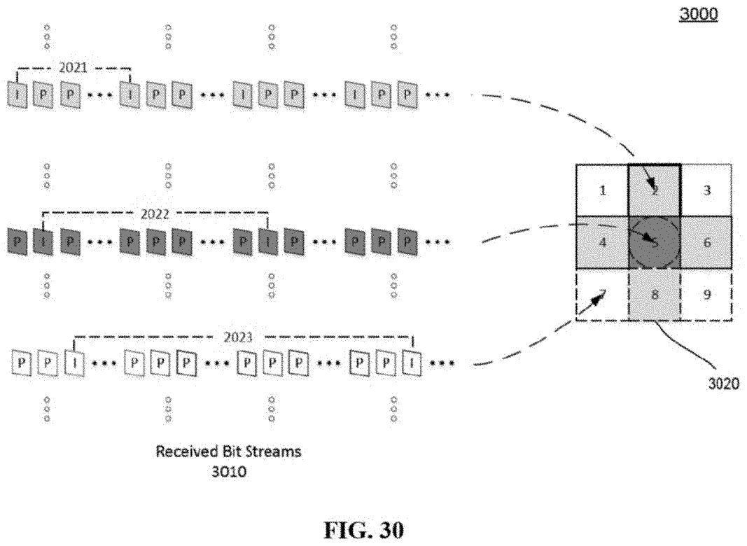

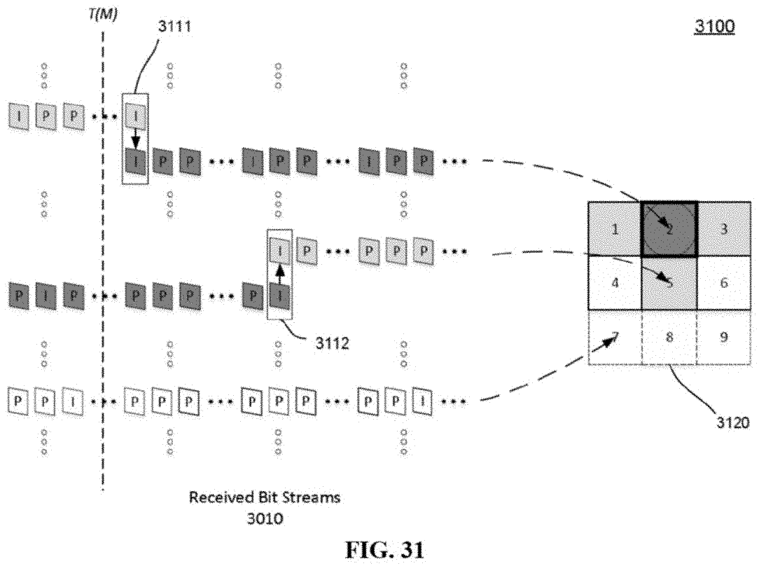

FIGS. 30-31 illustrates performing bit stream switching at the terminal side based on the exemplary configuration as shown in FIG. 17(b). For example, the tile 2 can be configured with the shortest IDR picture insertion cycle; the tiles 1, 3, 4, 5, and 6 can be configured with a medium IDR picture insertion cycle; and the tiles 7, 8, and 9 can be configured with the longest IDR picture insertion cycle.

As shown in FIG. 30, a viewport may initially locate at the tile 5 (e.g. when a user is focusing on the front portion of the view), then the binary data with high coding quality can be received (e.g. from the streaming server) for displaying at the tile 5. Additionally, binary data with medium coding quality can be received for the tiles 2, 4, 6, and 8; and binary data with low coding quality can be received for the tiles 1, 3, 7, and 9.

As shown in FIG. 31, an event may happen at the moment T(M), which triggers the bit stream switching. For example, as the viewing point moves from the tile 5 to the tile 2, e.g. when the viewer moves the viewport from the front portion of the view to the top portion of the view as intended by the video producer, the system may update the coding quality for each tile accordingly.

Using the distributed IDR image transmission technique, the bit stream switching may be performed separately for different tiles. In various embodiments, the bit stream switching may be performed for each tile in the order that respective portion of the IDR picture for each tile arrives. In the example as shown in FIG. 31, the IDR picture portion for the tile 2 arrives first, then the system can perform the bit stream switching 3111 for the tile 2 before other tiles. Following the order of the arrival of respective IDR picture portions, the system can perform bit stream switching progressively for the other regions. For example, the IDR picture portion for the tile 5 arrives after the IDR picture portion for the tile 2. Then, the bit stream switching 3112 for the tile 5 may be performed after the bit stream switching 3111 for the tile 2. Additionally, no bit stream switching needs to be performed for the tile 7 since there is no change of coding quality in tile 7. As the result of bit stream switching, image data with high coding quality can be displayed for the tile 5; image data with medium coding quality can be displayed for the tiles 1, 3, 4, 5 and 6; and image data with medium coding quality can be displayed for the tiles 7, 8, and 9, which optimize the viewing experience.

As illustrated in the above examples, using the progressive bit stream switching technique along with the distributed IDR image transmitting technique, the system can reduce the maximum bandwidth for performing bit stream switching, while allowing the region with high importance to be refreshed promptly without significant delay to improve viewing experience.

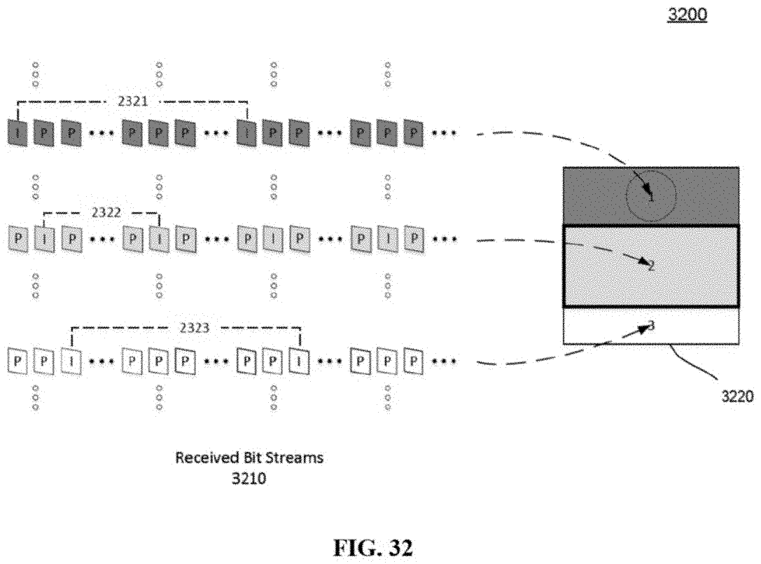

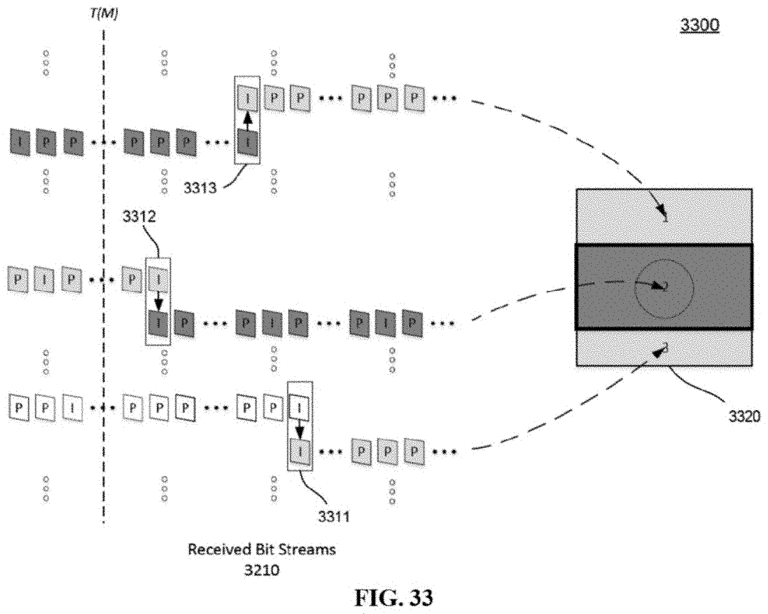

FIGS. 32-33 illustrates performing bit stream switching at the terminal side based on the exemplary configuration as shown in FIG. 22(a). For example, the slice 2 can be configured with the shortest IDR picture insertion cycle, and the slices 1 and 3 can be configured with longer IDR picture insertion cycles.

As shown in FIG. 32, a viewport may initially locate at the slice 1 (e.g. when the user is focusing on the top portion of the view). Thus, image data with high coding quality can be received (e.g. from the streaming server) for displaying at the slice 1. Additionally, image data with lower coding quality can be received for the slices 2 and 3.

As shown in FIG. 33, an event may happen at the moment T(M), which triggers the bit stream switching. For example, as the viewing point moves from the slice 1 to the slice 2, e.g. when the viewer moves the viewport from the top portion of the view to the central portion of the view, the system may update the coding quality for each slice accordingly.

Using the distributed IDR image transmission technique, the bit stream switching may be performed separately for different slices. As shown in FIG. 33, the bit stream switching may be performed for individual slice in the order that respective portion of the IDR picture arrives. In the example as shown in FIG. 33, the IDR picture portion for the slice 2 arrives first, then the system can perform the bit stream switching 3412 for the slice 2 before other slices. Then, following the order of the arrival of other IDR picture portions, the system can perform the bit stream switching progressively for the other regions. For example, the IDR picture portion for the slice 1 arrives before the IDR picture portion for the slice 3. Then, the bit stream switching 3413 for the slice 1 may be performed before the bit stream switching 3411 for tile 3, but after the bit stream switching 2412 for the slice 2. Thus, as the result of bit stream switching, image data with high coding quality can be displayed for the slice 2; and image data with medium coding quality can be displayed for the slices 1, and 3, which optimize the viewing experience.

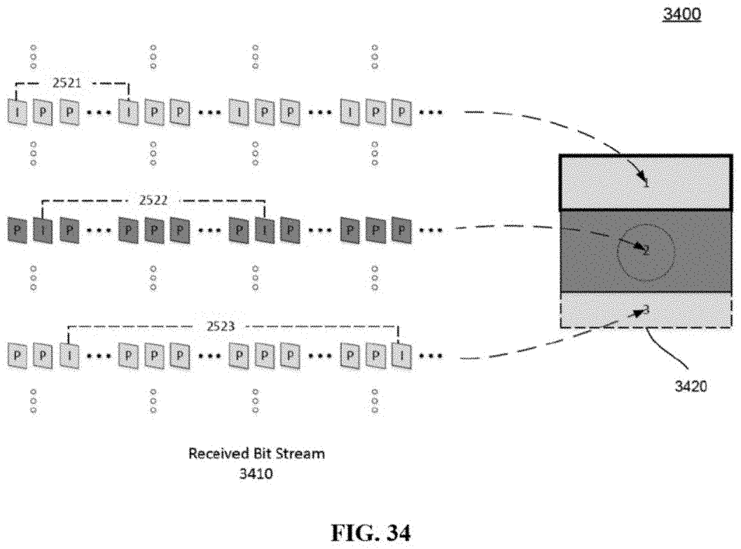

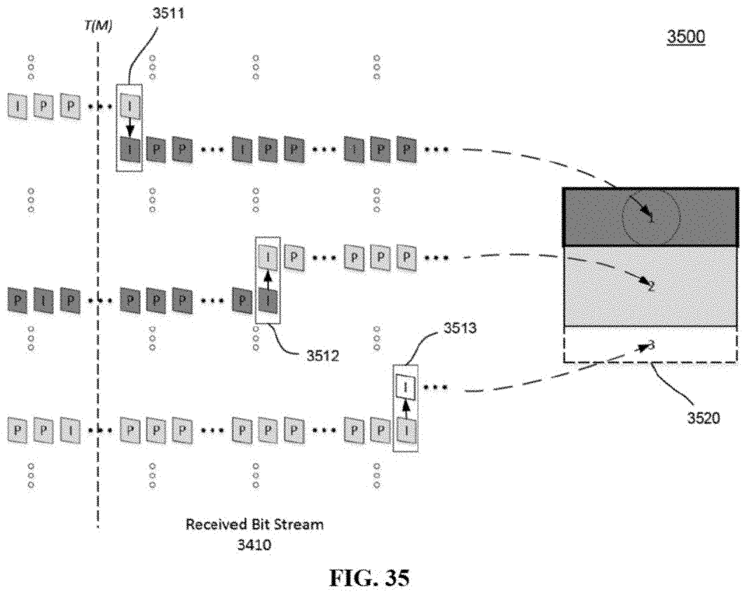

FIGS. 34-35 illustrates performing bit stream switching at the terminal side based on the exemplary configuration as shown in FIG. 22(b). For example, the slice 1 can be configured with the shortest IDR picture insertion cycle; and the slices 2, and 3 can be configured with a longer IDR picture insertion cycle.

As shown in FIG. 34, a viewport may initially locate at the slice 2 (e.g. when the user is focusing on the front portion of the view), then the binary data with high coding quality can be received (e.g. from the streaming server) for displaying at the slice 2. Additionally, binary data with lower coding quality can be received for the slices 1, and 3.

As shown in FIG. 35, an event may happen at the moment T(M), which triggers the bit stream switching. For example, as the viewing point moves from the slice 2 to the slice 1 (e.g. when the viewer moves the viewport from the front portion of the view to the top portion of the view as intended by the video producer), the system may update the coding quality for each slice accordingly.

Using the distributed IDR image transmission technique, the bit stream switching may be performed separately for different slices. As shown in FIG. 35, the bit stream switching may be performed for each tile in the order that respective portion of the IDR picture for each slice arrives. In the example as shown in FIG. 35, the DR picture portion for the slice 1 arrives first, the system can perform the bit stream switching 3511 for the slice 1 before other tiles. Following the order of the arrival of IDR picture portions, the system can perform bit stream switching progressively for the other regions. For example, the IDR picture portion for the slice 2 arrives after the IDR picture portion for the slice 1. Then, the bit stream switching 3512 for slice 2 may be performed after the bit stream switching 3511 for the slice 1, but before the bit stream switching 3513 for slice 3. As the result of bit stream switching, image data with high coding quality can be displayed for the slice 1; and image data with a lower coding quality can be displayed for the slices 2, and 3, which optimizes the viewing experience. Particularly, the slice 3 may be switched from medium coding quality to low coding quality, since the viewport moves away from the slice 3.

As illustrated in the above examples, using the progressive bit stream switching technique along with the distributed IDR image transmitting technique, the system can reduce the maximum bandwidth for performing bit stream switching, while allowing the region with high importance to be refreshed promptly without significant delay to improve viewing experience.

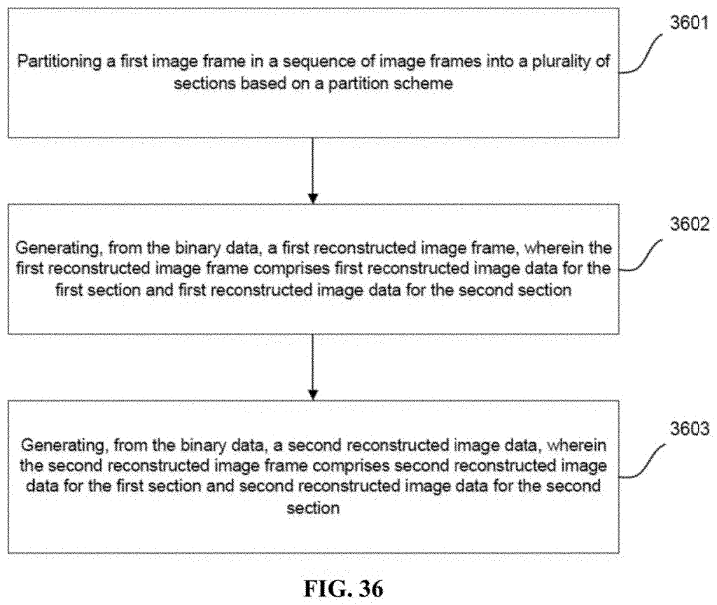

FIG. 36 illustrates a flow chart for supporting video streaming, in accordance with various embodiments of the present invention. As shown in FIG. 36, at step 3601, the system can receive a bit stream that comprises binary data for reconstructing a sequence of image frames, wherein each image frame in the sequence of image frames is partitioned into a plurality of sections based on a partition scheme, wherein the plurality of sections comprise at least a first section and a second section. At step 3602, the system can generate, from the binary data, a first reconstructed image frame, wherein the first reconstructed image frame comprises first reconstructed image data for the first section and first reconstructed image data for the second section. The first reconstructed image data for the first section can be reconstructed with a first prior coding quality when the first reconstructed image frame is before a first switching point that corresponds to a change of coding quality for the first section, and the first reconstructed image data for the second section can be reconstructed with a second prior coding quality when the second reconstructed image frame is before a second switching point that corresponds to a change of coding quality for the second section. At step 3602, the system can generate, from the binary data, a second reconstructed image data, wherein the second reconstructed image frame comprises second reconstructed image data for the first section and second reconstructed image data for the second section. The second reconstructed image data for the first section is reconstructed with a first posterior coding quality when the first reconstructed image frame is after the first switching point, and the second reconstructed image data for the first section is reconstructed with a second posterior coding quality when the second reconstructed image frame is after the second switching point.

FIG. 37 illustrates a movable platform environment, in accordance with various embodiments of the present invention. As shown in FIG. 37, a movable platform 3718 (also referred to as a movable object) in a movable platform environment 3700 can include a carrier 3702 and a payload 3704. Although the movable platform 3718 can be depicted as an aircraft, this depiction is not intended to be limiting, and any suitable type of movable platform can be used. One of skill in the art would appreciate that any of the embodiments described herein in the context of aircraft systems can be applied to any suitable movable platform (e.g., a UAV). In some instances, the payload 3704 may be provided on the movable platform 3718 without requiring the carrier 3702. In accordance with various embodiments of the present invention, various embodiments or features can be implemented in or be beneficial to the operating of the movable platform 3718 (e.g., a UAV).

In some embodiments, the movable platform 3718 may include one or more movement mechanisms 3706 (e.g. propulsion mechanisms), a sensing system 3708, and a communication system 3710. The movement mechanisms 3706 can include one or more of rotors, propellers, blades, engines, motors, wheels, axles, magnets, nozzles, or any mechanism that can be used by animals, or human beings for effectuating movement. For example, the movable platform may have one or more propulsion mechanisms. The movement mechanisms 3706 may all be of the same type. Alternatively, the movement mechanisms 3706 can be different types of movement mechanisms. The movement mechanisms 3706 can be mounted on the movable platform 3718 (or vice-versa), using any suitable means such as a support element (e.g., a drive shaft). The movement mechanisms 3706 can be mounted on any suitable portion of the movable platform 3718, such on the top, bottom, front, back, sides, or suitable combinations thereof.

In some embodiments, the movement mechanisms 3706 can enable the movable platform 3718 to take off vertically from a surface or land vertically on a surface without requiring any horizontal movement of the movable platform 3718 (e.g., without traveling down a runway). Optionally, the movement mechanisms 3706 can be operable to permit the movable platform 3718 to hover in the air at a specified position and/or orientation. One or more of the movement mechanisms 3706 may be controlled independently of the other movement mechanisms.

Alternatively, the movement mechanisms 3706 can be configured to be controlled simultaneously. For example, the movable platform 3718 can have multiple horizontally oriented rotors that can provide lift and/or thrust to the movable platform. The multiple horizontally oriented rotors can be actuated to provide vertical takeoff, vertical landing, and hovering capabilities to the movable platform 3718. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable platform 3718 (e.g., with respect to up to three degrees of translation and up to three degrees of rotation).

The sensing system 3708 can include one or more sensors that may sense the spatial disposition, velocity, and/or acceleration of the movable platform 3718 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 3708 can be used to control the spatial disposition, velocity, and/or orientation of the movable platform 3718 (e.g., using a suitable processing unit and/or control module). Alternatively, the sensing system 108 can be used to provide data regarding the environment surrounding the movable platform, such as weather conditions, proximity to potential obstacles, location of geographical features, location of manmade structures, and the like.

The communication system 3710 enables communication with terminal 3712 having a communication system 3714 via wireless signals 3716. The communication systems 3710, 3714 may include any number of transmitters, receivers, and/or transceivers suitable for wireless communication. The communication may be one-way communication, such that data can be transmitted in only one direction. For example, one-way communication may involve only the movable platform 3718 transmitting data to the terminal 3712, or vice-versa. The data may be transmitted from one or more transmitters of the communication system 3710 to one or more receivers of the communication system 3712, or vice-versa. Alternatively, the communication may be two-way communication, such that data can be transmitted in both directions between the movable platform 3718 and the terminal 3712. The two-way communication can involve transmitting data from one or more transmitters of the communication system 3710 to one or more receivers of the communication system 3714, and vice-versa.

In some embodiments, the terminal 3712 can provide control data to one or more of the movable platform 3718, carrier 3702, and payload 3704 and receive information from one or more of the movable platform 3718, carrier 3702, and payload 3704 (e.g., position and/or motion information of the movable platform, carrier or payload; data sensed by the payload such as image data captured by a payload camera; and data generated from image data captured by the payload camera). In some instances, control data from the terminal may include instructions for relative positions, movements, actuations, or controls of the movable platform, carrier, and/or payload. For example, the control data may result in a modification of the location and/or orientation of the movable platform (e.g., via control of the movement mechanisms 3706), or a movement of the payload with respect to the movable platform (e.g., via control of the carrier 3702). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view).

In some instances, the communications from the movable platform, carrier and/or payload may include information from one or more sensors (e.g., of the sensing system 3708 or of the payload 3704) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable platform, carrier, and/or payload. Such information from a payload may include data captured by the payload or a sensed state of the payload. The control data transmitted by the terminal 3712 can be configured to control a state of one or more of the movable platform 3718, carrier 3702, or payload 3704. Alternatively or in combination, the carrier 3702 and payload 3704 can also each include a communication module configured to communicate with terminal 3712, such that the terminal can communicate with and control each of the movable platform 3718, carrier 3702, and payload 3704 independently.

In some embodiments, the movable platform 3718 can be configured to communicate with another remote device in addition to the terminal 3712, or instead of the terminal 3712. The terminal 3712 may also be configured to communicate with another remote device as well as the movable platform 3718. For example, the movable platform 3718 and/or terminal 3712 may communicate with another movable platform, or a carrier or payload of another movable platform. When desired, the remote device may be a second terminal or other computing device (e.g., computer, laptop, tablet, smartphone, or other mobile device). The remote device can be configured to transmit data to the movable platform 3718, receive data from the movable platform 3718, transmit data to the terminal 3712, and/or receive data from the terminal 3712. Optionally, the remote device can be connected to the Internet or other telecommunications network, such that data received from the movable platform 3718 and/or terminal 3712 can be uploaded to a website or server.

Many features of the present invention can be performed in, using, or with the assistance of hardware, software, firmware, or combinations thereof. Consequently, features of the present invention may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present invention can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present invention can be incorporated in software and/or firmware for controlling the hardware of a processing system, and for enabling a processing system to interact with other mechanism utilizing the results of the present invention. Such software or firmware may include, but is not limited to, application code, device drivers, operating systems and execution environments/containers.

Features of the invention may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for video streaming, comprising:
using a scheme that partitions each image frame in a sequence of image frames into a plurality of sections, wherein the plurality of sections comprise at least a first section and a second section;
obtaining a first set of encoded data in different coding qualities for the first section, and obtaining a second set of encoded data in different coding qualities for the second section;
determining a first switching point that corresponds to a change of coding quality for the first section, and determining a second switching point that corresponds to a change of coding quality for the second section;
selecting, from the first set of encoded data, encoded data with a first prior coding quality before the first switching point and encoded data with a first posterior coding quality after the first switching point;
selecting, from the second set of encoded data, encoded data with a second prior encoding quality before the second switching point and encoded data with a second posterior encoding quality after the second switching point; and
incorporating the selected encoded data in a bit stream.

2. The method of claim 1, wherein the change of encoding quality for each of the first section and the second section is determined based on user information.

3. The method of claim 2, wherein the user information comprises viewport information, which indicates a viewing point of a user.

4. The method of claim 2, wherein the user information comprises region of interest (ROI).

5. The method of claim 1, wherein the change of coding quality for the first section and the change of coding quality for the second section are triggered by an event.

6. The method of claim 5, wherein the first switching point for the first section is different from the second switching point for the second section.

7. The method of claim 5, wherein the first section is associated with a first set of periodic random access points, and the second section is associated with a second set of periodic random access points.

8. The method of claim 7, wherein the first switching point for the first section is determined based on a first random access point in the first set of periodic random access points after the event and the second switching point for the second section is determined based on a second random access point in the second set of periodic random access points after the event.

9. The method of claim 7, further comprising configuring the first set of periodic random access points associated with the first section with a first interval, and configuring a second periodic random access points associated with the second section with a second interval.

10. The method of claim 9, wherein the first interval and the second interval are different.

11. The method of claim 1, wherein the selected encoded data at the first switching point comprises a first refreshing portion with the first posterior coding quality for the first section and the selected encoded data at the second switching point comprises a second refreshing portion with the second posterior coding quality for the second first section.

12. The method of claim 11, wherein the first refreshing portion comprises a portion of a first instantaneous decoder refresh (IDR) picture, and the second refreshing portion comprises a second portion of an instantaneous decoder refresh (IDR) picture.

13. The method of claim 1, further comprising using an encoder to generate the first set of encoded data in different coding qualities for the first section, and to generate the second set of encoded data in different coding qualities for the second section.

14. The method of claim 13, wherein the encoder operates to share one or more coding steps.

15. The method of claim 13, wherein the encoder operates to use a first set of quantization parameters to generate the first set of encoded data in different coding qualities for the first section and use a second set of quantization parameters to generate the second set of encoded data in different coding qualities for the second section.

16. The method of claim 15, wherein the first set of quantization parameters and the second set of quantization parameters are the same.

17. The method of claim 1, wherein each section of the plurality of sections is a tile, which is a rectangular region in each image frame of the sequence of image frames.

18. The method of claim 1, wherein each section of the plurality of sections is a slice, which is a sequence of coding blocks or a sequence of coding block pairs in each image frame of the sequence of image frames.

19. A system for video streaming, comprising:
one or more microprocessors;
a streaming controller running on the one or more microprocessors, wherein the streaming controller operates to
use a scheme that partitions each image frame in a sequence of image frames into a plurality of sections, wherein the plurality of sections comprise at least a first section and a second section;
obtain a first set of encoded data in different coding qualities for the first section, and obtain a second set of encoded data in different coding qualities for the second section;
determine a first switching point that corresponds to a change of coding quality for the first section, and determine a second switching point that corresponds to a change of coding quality for the second section;
select, from the first set of encoded data, encoded data with a first prior coding quality before the first switching point and encoded data with a first posterior coding quality after the first switching point;
select, from the second set of encoded data, encoded data with a second prior encoding quality before the second switching point and encoded data with a second posterior encoding quality after the second switching point; and
incorporate the selected encoded data in a bit stream.

20. An apparatus, comprising:
a processor; and
a non-transitory computer-readable medium with instructions stored thereon, that when executed by the processor, perform the steps comprising:
using a scheme that partitions each image frame in a sequence of image frames into a plurality of sections, wherein the plurality of sections comprise at least a first section and a second section;
obtaining a first set of encoded data in different coding qualities for the first section, and obtaining a second set of encoded data in different coding qualities for the second section;
determining a first switching point that corresponds to a change of coding quality for the first section, and determining a second switching point that corresponds to a change of coding quality for the second section;
selecting, from the first set of encoded data, encoded data with a first prior coding quality before the first switching point and encoded data with a first posterior coding quality after the first switching point;
selecting, from the second set of encoded data, encoded data with a second prior encoding quality before the second switching point and encoded data with a second posterior encoding quality after the second switching point; and
incorporating the selected encoded data in a bit stream.

21.-40. (canceled)
